(19) United States
(12) Patent Application Publication
(10) Pub. No.: US 2011/0212774 A1
(43) Pub. Date: Sep. 1, 2011

(54) TERMINAL INCLUDING A BUTTON AND BUTTON HAVING PROJECTED IMAGES AND METHOD

(76) Inventors: KARL WUDTKE, Las Vegas, NV (US); Brian Keith Lanning, Las Vegas, NV (US); Vernon Bernard, Las Vegas, NV (US)

(21) Appl. No.: 12/826,512

(22) Filed: Jun. 29, 2010

Related U.S. Application Data
(63) Continuation-in-part of application No. 12/271,781, filed on Nov. 14, 2008.
Application No. 12/271,781 is a continuation-in-part of application No. 12/271,802, filed on Nov. 14, 2008.

(51) Int. Cl. A63F 13/00

(52) U.S. Cl. 463/30

(57) ABSTRACT

A display terminal and gaming device is set forth which includes a button having a screen to display images. A digital light projector is disposed to render selected images or video at the button screen. The images may relate to or augment the display of content by the terminal or gaming device. The images or video may be locally or remotely controlled.

### CROSS-REFERENCE TO RELATED APPLICATIONS

This application is a continuation-in-part of U.S. patent application Ser. Nos. 12/271,781 titled “Gaming Machine Having a Curved Display” and 12/271,802 titled “Gaming Machines Having a Curved Display and related Methods” both of which were filed Nov. 14, 2008 all of which are hereby incorporated by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

The present invention is directed to display terminals such as a video terminal devices including gaming devices. More particularly it relates to such devices and a button therefore where the button includes a three dimensional backlights screen and a projector for display images and video on the screen.

### BACKGROUND

Gaming machines have been developed having various features to capture and maintain player interest. Some features are directed to increasing or providing the player with the opportunity to win larger sums of money. For example, gaming machines may include second chance games that provide a player with additional opportunities to obtain a winning outcome. Alternatively, gaming machines may be tied into progressive gaming systems that award large progressive jackpots.

In addition to providing players with more opportunities to obtain a winning outcome or win a large sum of money, gaming machines have increased the number of features and grown in sophistication in order to increase player participation or interest in a game. For example, the mechanical reels of traditional gaming machines have been replaced with video depictions of spinning reels. These video gaming machines provide a richer gaming experience for players by including graphics or animation as part of the game. However, overly complex video displays on a gaming machine may turn off player participation because players become frustrated with the game or are unwilling to learn or decipher all the information provided on the video display. Accordingly, there is a continuing need for slot machines variants that provide a player with enhanced excitement without departing from the original slot machine gaming concept.

In regards to display terminal devices including gaming devices, it has been known to provide such devices with a button panel having one or more buttons which can be displaced by the user to enter a prompt or selection to a controller. In one example the device may be a kiosk such as an airline ticketing or check-in kiosk having a video display and in communication with the airline ticketing database host and operative controller. A user responds to prompts and enters selections via a push button panel. Another example of a kiosk is a vending kiosk where a user makes selections by using one or more push buttons.

Gaming devices, i.e. gaming machines, also include a controller which controls the content display at one or more displays o the gaming device. Using a panel of push buttons the player can make selections and interface with the controller to play the game, make wagers, play feature games, cash out their winnings or the like.

In the prior art the push buttons included decals or were etched to self-describe the function of the button. An alternative is to provide a touch screen interface at the display to display touch activated buttons.

In the past gaming devices were dedicated to a single game. It later became the practice to include several games in the same gaming device cabinet, e.g. a multi-game gaming device from which the player could select the desired game. Recently downloadable and server based gaming have been developed. In a downloadable gaming configuration a server can download one or more different games to the gaming terminal device for the player to select to play. For server based gaming many of the game's critical functions are handled at a remote server which can host any number of a plurality of games.

As can be appreciated where multiple games are available for play at a gaming device (or where a terminal or kiosk can be remotely configured) the button functions may be required to change as well. It has been known to provide touch screen buttons on the game display which can be reconfigured to correspond to the game's play functions. However, where the buttons are push buttons (i.e. not touch screen buttons) reconfiguration is problematic. In commonly owned U.S. Patent Application by Wudtke et al titled “Methods Employing Action Buttons” filed Jun. 27, 2008 and there is a disclosed a button which includes a flat panel display which can be actively changed. Buttons such as buttons for gaming devices are subject to abuse such as by pounding by the player. Any button must be robust to be able to withstand such abuse.

It would be advantageous to provide for the terminal device, including gaming machines, with a button whose appearance can be changed to reflect, for example, an altered or additional function, to provide additional features, to display images and video to attract users/players and to increase the utility and, in the case of gaming devices, the entertainment value of the device. It would also be advantageous to provide a method for using such a button. Further it would be advantageous to provide a button module including such a button which may be easily provided on and retrofit to existing and new devices. With reference to the above advantages it would also be advantageous to provide a button having those characteristics while being robust. Additionally it would be advantageous from an entertainment and instructional viewpoint to confer onto a mechanical button where desired a three-dimensional appearance.

### SUMMARY

There is, therefore, provided according to the present invention an improved display terminal device of the type which includes a display and a controller to control the display to display content. The improvement includes a button which can be manipulated by a user to provide an input signal to the controller. The button has a three dimensional backlit screen (height, width and depth) such as by the button being a three dimensional sphere, dome-shaped, cube, pyramid or the like. A digital projector is provided to broadcast images to backlight the screen such that the images are viewable by the user. A processor such as a video processor controls the images provided by the projector. The screen and images may be configured to produce images at the button which appear to the user to be three dimensional. In a preferred embodiment the button is transparent having an exterior surface and an interior surface defining the screen. Where, for example, the button is spherical, the screen is likewise spherical and the images may be configured to make the button appear to be spherical object such as a ball, globe or the like. The images may be relatively static or may be video images or an animated string of images. The images may be related or unrelated to the displayed content.

Where the projector has a throw ratio, the optical path distance from the projector to the screen may be fixed such that the distance fits the images to the screen. One or more reflecting surfaces may be used to fix the distance.

Where the device is a gaming device, the device includes one or more displays for displaying content including gaming content. A controller is configured to display content including gaming content at the display. A displaceable button such as a push button is provided to generate input to the controller. The button has a three dimensional body defining an exterior and an interior surface with at least a portion of one of the surfaces defining a screen to present backlit images to the player. A processor and digital projector project images onto the screen to render the images for view by the player. The three dimensional screen and images are configured to render the images as three dimensional to the player. The processor and/or controller may control the images to be coordinated with the content displayed at the display.

The images displayed at the button may be images generated by the game controller, a separate processor associated with the projector or by a gaming device peripheral or by the network to which the gaming device is connected. For example, the gaming device network may generate a bonus to the gaming machine. Images would be displayed at the button of a pair of die and the player is invited to press the button whereupon the network and/or local controller selects an outcome and the images show the rolling of the die to produce an outcome which may affect the value of the bonus.

Also set forth is a method for configuring a terminal or gaming device to include the above described button as well as a button module including the button.

Other features and advantages will become apparent from the following detailed description, taken in conjunction with the accompanying drawings, which illustrate by way of example, the features of the various embodiments.

### BRIEF DESCRIPTION OF THE DRAWINGS

FIG. 1 is a perspective view of one embodiment of a gaming device having a curved display.

FIG. 2 is a schematic diagram of the components of a curved display system.

FIG. 3 is an exploded view of the curved display system of FIG. 1.

FIG. 4 is an exploded view of another embodiment of a curved display system.

FIG. 5 is an exploded view of one embodiment of a curved display system having a touch panel system.

FIG. 6 is one embodiment of an exploded perspective view of the touch panel system of FIG. 5.

FIG. 7 is an operational flow diagram of a gaming device having a touch panel system.

FIG. 8 is an operational flow diagram of a gaming device having a touch panel system.

FIGS. 9A-9B illustrates one embodiment of a touch gesture for initiating a game presented on a gaming device.

FIGS. 10A-10B illustrates one embodiment of a touch gesture for selecting active pay lines.

FIGS. 11A-11C illustrates touch gestures for adding and removing reels from a game.

FIGS. 12A-12B illustrates one embodiment of a touch gesture for moving symbols between reels of a game.

FIGS. 13A-13D illustrates touch gestures for adding and removing symbols from reels of a game.

FIG. 14 is a perspective view of one embodiment of a curved display system for a video gaming device.

FIG. 15 is a perspective view of another embodiment of a gaming device having a curved display and a secondary display positioned above the curved display.

FIG. 16 is a perspective view of an embodiment of a gaming device having a main curved display system and a secondary curved display system.

FIGS. 17A-17B are perspective views of an embodiment of a gaming device having a main curved display system and a secondary display system composed of a LCD positioned in front of a curved display system.

FIG. 17C is a perspective view of another embodiment of a gaming device having a curved display.

FIG. 18 is a schematic representation of one embodiment of a gaming system including one or more gaming devices having curved displays.

FIG. 19 is a perspective view of yet another embodiment of a gaming device having a curved display.

FIG. 20 is a perspective view of the gaming device of FIG. 19 with the main door opened.

FIG. 21 is a cutaway, side view of the gaming device of FIG. 19.

FIG. 22 is a perspective view of a gaming device including a button according to the present invention.

FIG. 23 is a top view of the gaming machine if FIG. 22.

FIG. 24 is a top view of a substrate supporting the button of FIG. 22.

FIG. 25 is a front view of the substrate and button of FIG. 24.

FIGS. 26A and B represent a block diagram of the physical and logical components of the gaming device of the type shown in FIG. 22.

FIG. 27 is a block diagram of the logical components of a gaming kernel for a gaming device.

FIGS. 28A and B represent a schematic block diagram showing the hardware elements of a networked gaming system.

FIG. 29 is a perspective view of one embodiment of a button according to the present invention.

FIG. 30 is a schematic showing arrangement of the optical path for the projector.

FIG. 31 is a perspective view of an example of the button of the present invention displaying images.

FIG. 31 is a perspective view of another example of the button of the present invention displaying images.

### DETAILED DESCRIPTION

The present invention is directed to a user or player interface for display terminal devices such as a kiosk, video terminal or gaming device. While the description hereinafter set forth is directed primarily at such devices configured as gaming terminal devices, it should be understood that the present invention can be used outside of a gaming environment such as for kiosks, vending devices or the like.

Described herein are various gaming devices having video depictions of one or more mechanical reels projected onto a curved display. According to one embodiment, a digital light processing (DLP) projector that presents video images of one or more reels on the curved display. In one embodiment, the curved display is shaped to simulate the look of mechanical reels. Additionally, the high resolution of the DLP projector presents video images that give a player the impression that the combination of the curved display and the video images are physical, mechanical reel strips.

In other embodiments, shrouds (either physical or video-depictions of the shrouds) may be placed between the video depiction of the reels to provide a more realistic impression of mechanical reels. Optionally, the gaming machines may include other audio and visual features to enhance the perception that the video images and curved display are mechanical reels. For example, the video images may shudder to simulate the torque of stopping the spinning mechanical reels. Alternatively, the video images may have visual imperfections to simulate mechanical reels. Furthermore, audio sound effects may be coordinated with the movement and stopping of the reels to further simulate a gaming machine having mechanical reels.

Because the gaming device in one embodiment is video-based, the gaming machine also maintains the flexibility of a video gaming machine. For example, the DLP projector may present pay lines directly on and/or around the symbols that comprise a winning outcome. The pay lines may be animated or otherwise highlight the winning combination of symbols. Optionally, the winning symbols may be animated on the “virtual” reel strip. For example, the symbols that form a winning pay line may interact with one another or the symbols may be emphasized by expanding the size of the symbol. Alternatively, a short animated movie may be presented at one or more of the game indicia on a winning pay line. In another embodiment, the images of the game indicia on the “virtual” strips may be altered so that a “wild” symbol morphs into the game indicia that forms a winning combination. For example, a “wild” symbol may morph into a “7” to complete a winning combination of “7-7-7.” In yet another embodiment, the reel strip color may be altered in response to a particular game outcome or trigger for a bonus game.

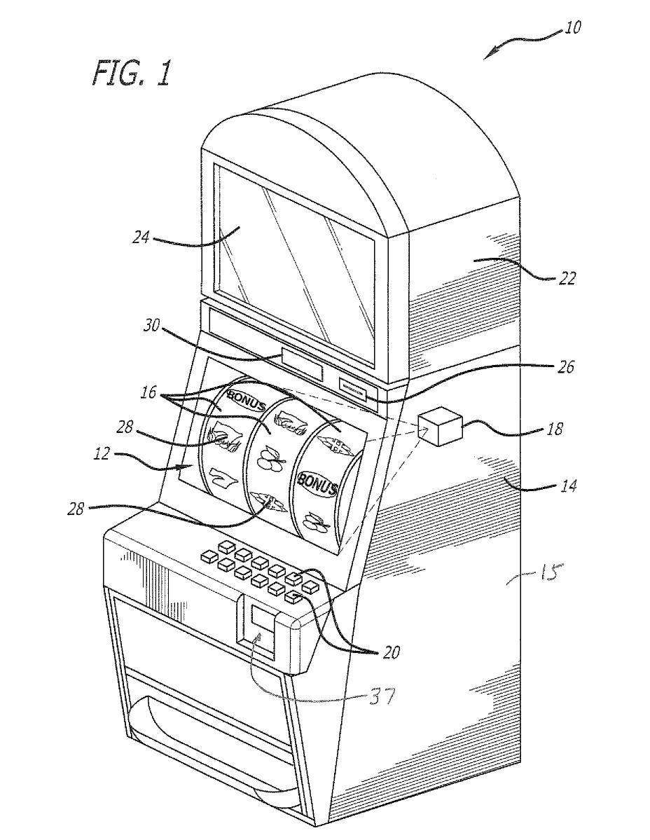

Referring now to the drawings, wherein like reference numerals denote like or corresponding parts throughout the drawings and, more particularly to FIGS. 1-18, there are shown various embodiments of a gaming device having a curved display system. More specifically, as shown in FIG. 1, the gaming device 10 includes a curved material 12 positioned within the main gaming cabinet 14. A video image 16 of one or more mechanical reels is projected onto the curved material 12 by a digital light projection (DLP) device 18 or other light projection system. In one embodiment, the DLP device 18 is a Samsung P400 LED projector. As shown in FIG. 1, the video image 16 depicts an image of three mechanical reels. In another embodiment, the video image 16 may depict video images of five mechanical reels.

It is contemplated that the video image 16 may present any number of reels ranging from one reel to five or more reels. In another embodiment, the gaming device 10 may include a combination of one or more mechanical reels and video images of one or more reels presented on a curved display. The DLP device 18 may project one or more video images 16 onto the curved display 12. Accordingly, it is possible to present a game that is a combination of mechanical reels as well as video reels. The video reels may be part of the primary game or may be presented as a portion of a secondary game.

As shown in FIG. 1, the video image 16 of each of reels also presents one or more game indicia 28. In one embodiment, the video image of each reel includes three game indicia 28. In another embodiment, the video image of each reel includes four game indicia 28, thereby increasing the number of paylines available for wagering. Optionally, the game indicia 28 may be animated when the indicia 28 is a component of a winning outcome on an active pay line. Alternatively, the game indicia 28 morphs into a symbol that forms a winning outcome. For example, a “wild” symbol will morph (i.e., change into) a symbol that will form a winning outcome. Accordingly, for a winning outcome of “cherry-wild-cherry,” the “wild” symbol will change into a “cherry” symbol.

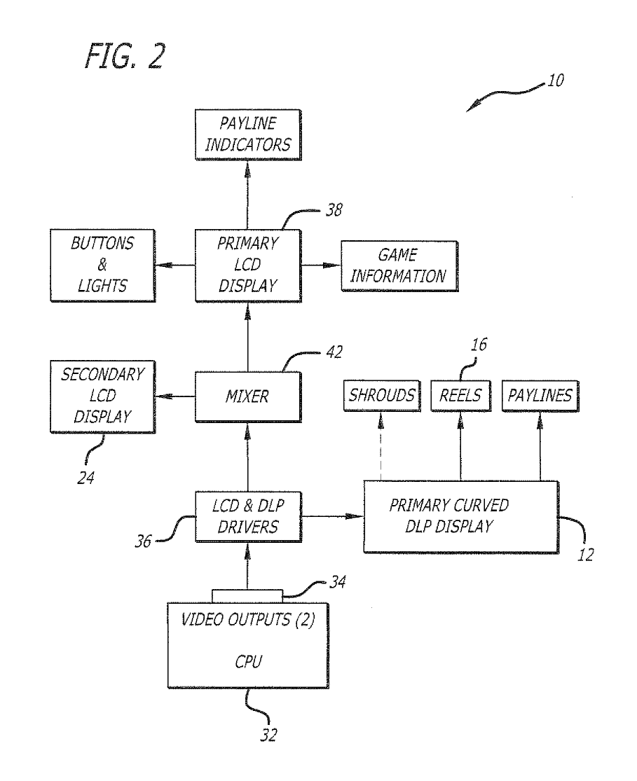

FIG. 2 illustrates a schematic diagram of the components of one embodiment of a gaming device 10 having a curved display system. The gaming device 10 includes a micro-controller with a central processing unit (CPU) 32 one or more video outputs 34, and a system memory (not shown). The CPU 32 is in communication with a LCD and DLP control driver 36 via video outputs 34. As shown in FIG. 3, the LCD and DLP control drivers 36 are integral components. In other embodiments, it is contemplated that the LCD and DLP control drivers 36 are separate components. The LCD control driver 36 interfaces with primary LCD display 38 and the secondary LCD display 24 via a mixer 42. In another embodiment, the LCD control driver 36 may directly interface with the primary LCD display 38 and secondary LCD display 24.

The primary LCD display 38 may be used to display buttons and lights, pay line indicators, and other game information such as, but not limited to, credits available, credits won, wager size, wager per pay line, or wager denomination. The secondary LCD display 24 may be used to display other game related information such as, but not limited to, one or more bonus games, pay tables, game theme information, jackpot information, progressive jackpot information, jackpot meters, or the like. The secondary LCD 24 may also display non-gaming related information such as, but not limited to, player account information, advertisements, casino promotions, news, one or more sporting events, or the like.

FIGS. 3-5 illustrate exploded views of various embodiments of a curved display system 50. The curved display system 50 is described by relating the components of the curved display system 50 in relation to layers with the outermost layer in front of the gaming cabinet 14 (i.e., outer layer is closest to the game patron) and the innermost layer located within the gaming cabinet.

As shown in FIG. 3, the outermost layer of a transparent material. The transparent material 52 may be flush with the gaming cabinet 14 or slightly recessed within the gaming cabinet. In one embodiment, the transparent material 52 may be one or more layers of glass, polycarbonate, plexiglass, or other transparent material known or developed in the art. The transparent material 52 may also include printed graphics or a printed frame around the perimeter of the transparent material. In another embodiment, the transparent material 52 may be one or more LCD displays. In yet another embodiment, the transparent material 52 or the LCD displays may also include a touch screen system 54, as shown in FIG. 5.

Referring to FIG. 3, one more shrouds 56 are placed in front of the curved material 12. The shrouds are physical pieces of material positioned in front of the curved material. The shrouds 56 are placed between the images of the reels 16 that are projected onto the curved material 12 and give the player the impression of separate reel strips. The shrouds 56 may be placed directly on the curved material 12. In another embodiment, the shrouds 56 may be positioned between the transparent material 52 and the curved material 12. In yet another embodiment, the shrouds 56 are placed on the transparent material 52. In another embodiment, the shrouds are video images that are placed between the video images of the reels.

As shown in FIGS. 3-5, a curved material 12 is positioned behind the transparent material 52. In one embodiment, a portion of the curved material 12 touches the transparent material 52. Alternatively, the curved material 12 is in spaced relation to the transparent material 52. The curved material 12 is made of a material that is optically clear such as, but not limited to, glass, polycarbonate, plexiglass, acrylic, or the like. The curved material 12 has a radius of curvature similar to the radius of curvature of a mechanical reel. The curved material 12 may include diffusion or beaded refractive technology. The curved material 12 is generally high contrast, high resolution, and maximum uniformity. According to one embodiment, the radius of curvature is approximately 4.5″ and dimensions of approximately 16.5″ wide and 5.75″ tall. However, as those skilled in the art will appreciate, the curved material may have any width, height, or radius of curvature that approximates or simulates the appearance of a mechanical reel. A shown in FIG. 3, the curved material 12 is a single piece of material. In another embodiment, two or more pieces of a curved material may be used to form a curved display. In one embodiment, the pieces may be slightly spaced apart to give the appearance of separate reels.

As shown in FIG. 3, glossy coating 58 is applied to the outer surface of the curved material 12. In another embodiment, the outer surface of the curved material 12 is polished to a finish having a glossy or reflective properties. The glossy finish reflects light to further to simulate or mimic a mechanical reel. Optionally, a finish or coating 58 may be applied to the inner surface of the curved material to improve the appearance of the images projected on the inner surface, as shown in FIG. 3.

In another embodiment, the glossy coating 58 may be replaced with a gradient coating provided on the outer and/or inner surfaces of the curved material 12. The gradient coating provides greater depth of the image projected onto the curved material. The gradient coating may be darker at the periphery of the curved material 12 and lighter in the middle of the curved material. Alternatively, the gradient coating is darker in the middle of the curved material 12 and lighter about the periphery of the curved material. In yet another embodiment, the gradient coating is provided in addition to the glossy coating. For example, the gradient coating and the glossy coating both may be applied to the outer surface of the curved material 12. Alternatively, the glossy coating is applied to the outer surface of the curved material 12 and the gradient coating is applied to the inner surface of the curved material.

In another embodiment, a diffusion screen (not shown) is provided in front of or behind the curved display 12. Alternatively, the diffusion screen is coupled directly to the front and/or the back surface of the curved display 12. The diffusion screen may be made from a thin, semi-flexible acrylic optical beads. In one embodiment, a rigid metal frame encapsulates the diffusion screen to help achieve a uniform and repeatable manufacturing of the screen.

As shown in FIGS. 3-5, a DLP device 18 is positioned behind the curved material 12. The DLP device 18 projects video images onto the inner surface of the curved material 12. The DLP device 18 generally includes a DLP chip, a flywheel color filter, and a light source. In one embodiment, the light source is a high intensity discharge (HID) projector. In another embodiment, the light source is a light emitting diode (LED) projector.

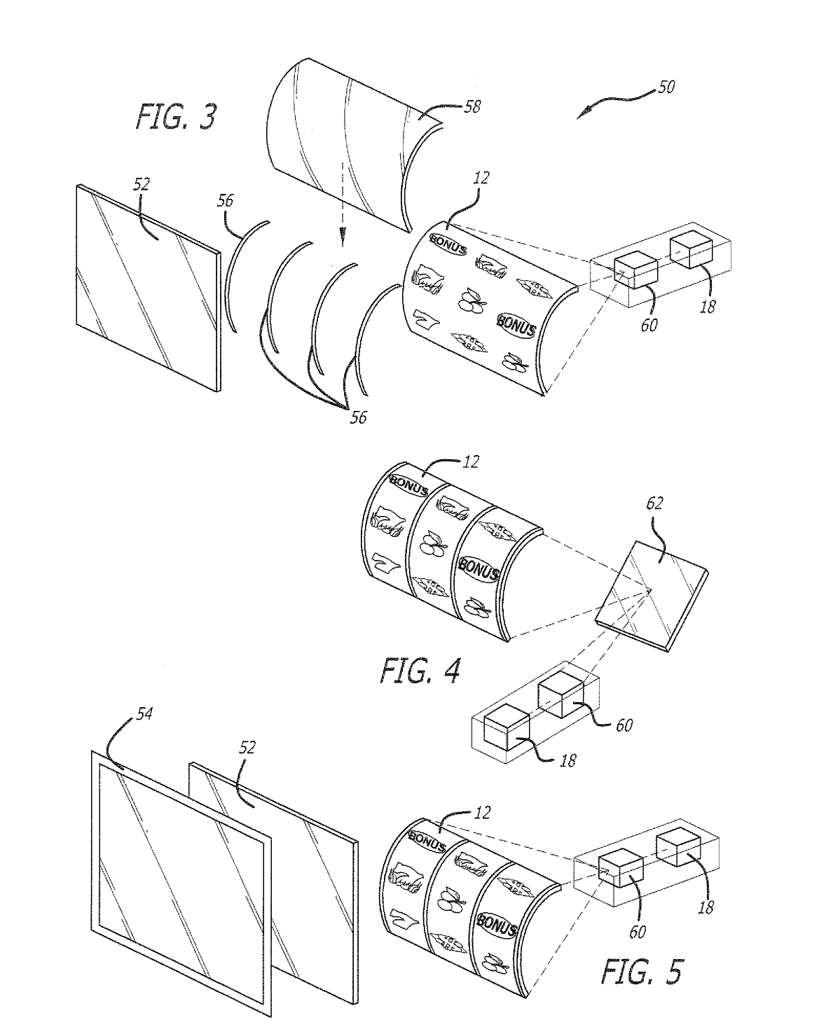

The DLP device 18 may directly project video images onto the inner surface of the curved material 12 as shown in FIGS. 3 and 5. Alternatively, the video image is indirectly projected onto the inner surface of the curved material by reflecting the video images off a mirror 62, as shown in FIG. 4. In one embodiment, the DLP device 18 projects an image having a display resolution of 800×600, 1280×720, 1280×1024 or 1980×1080. As those skilled in the art will appreciate, these resolution values may be approximate as the resolution may be lower or higher than the cited resolution values. For example, the DLP device 18 may project an image of a plurality of reels onto the curved material having a resolution of approximately 1360×768. The DLP device 18 may have an aspect ratio of approximately 16:9 or any other aspect ratio depending on the size of the curved material 12. Generally, the DLP device will have a brightness of approximately 300 to approximately 500 ANSI Lumens. The color depth may be 8-bit, 16.7M colors. As those skilled in the art will appreciate, the DLP device 18 may have any brightness or color depth.

As shown in FIGS. 3-5, a lens 60 is positioned between the curved material and the DLP device 18. In one embodiment, the lens 60 may be an anamorphic lens may be used shorten or stretch the image to an appropriate size. In other embodiments, a video scaler or other software may be used to reduce or increase the size of the image in order for the image to fit within the curved display. In another embodiment, the larger image may still projected (i.e., overscan) onto the curved material, but the extra image that is over-projected is not visible to the game patron as a screen or other partition is used to block out the periphery of the curved material. The over-projection allows the operator to digitally adjust the image of the reels and account for any tolerances that may not be maintained during the assembly of critical optical components including, but not limited to, the projector, mirror, or screens. In one embodiment, the image is over-projected by approximately 0.4 inches. As those skilled in the art will appreciate, the amount of over-projection may be a larger or smaller value depending upon the tolerances maintained during the assembly process.

In some embodiments, the edges of the projected image are bowed/distorted, thereby creating a fish-eye effect. This effect may be corrected using warping software and/or hardware to correct the projected image. In another embodiment, a warping template, which is previously created for a particular hardware configuration, may be applied to correct the projected image.

FIG. 4 illustrates a curved display system 50 in which the image of the reels is indirectly projected onto the curved material 12. The curved display system 50 includes a short-throw lens 60 and a front-coated mirror 62 to achieve the necessary image size while working with the dimensional constraints (i.e., depth) of the gaming cabinet 14. Otherwise stated, the DLP device 18 requires a particular throw distance in order to project a particular image size, but the gaming cabinet 14 is not large enough to accommodate such a throw distance. For example, according to one embodiment, the combination of the short-throw lens 60 and the front-coated mirror 62 provides a throw distance of approximately 25″.

In alternate embodiments, a combination of a short-throw lens 60 and a back-coated mirror may be used to achieve the proper throw distance for the DLP device 18. In another embodiment, a combination of a short throw-lens and two or more mirrors may be used to achieve the proper throw distance. In other embodiments, two or more mirrors may be used to provide the appropriate light path length while reducing the overall depth of the enclosure. In yet another embodiment, the gaming cabinet (not shown) is sized to allow the DLP device 18 to directly project an image onto the curved display 12 without needing a short-throw lens and/or any mirrors.

FIG. 5 illustrates another embodiment of a curved display system 50 having a touch screen 54 placed in front of the curved display 12. As shown in FIG. 5, the touch screen 54 is a flat surface that is spaced apart from the curved display 12, as disclosed in U.S. patent application Ser. No. 11/209,895, filed Aug. 23, 2005, which is hereby incorporated by reference. In another embodiment, the touch screen 54 is curved to conform to or approximately conform to the shape of the curved display.

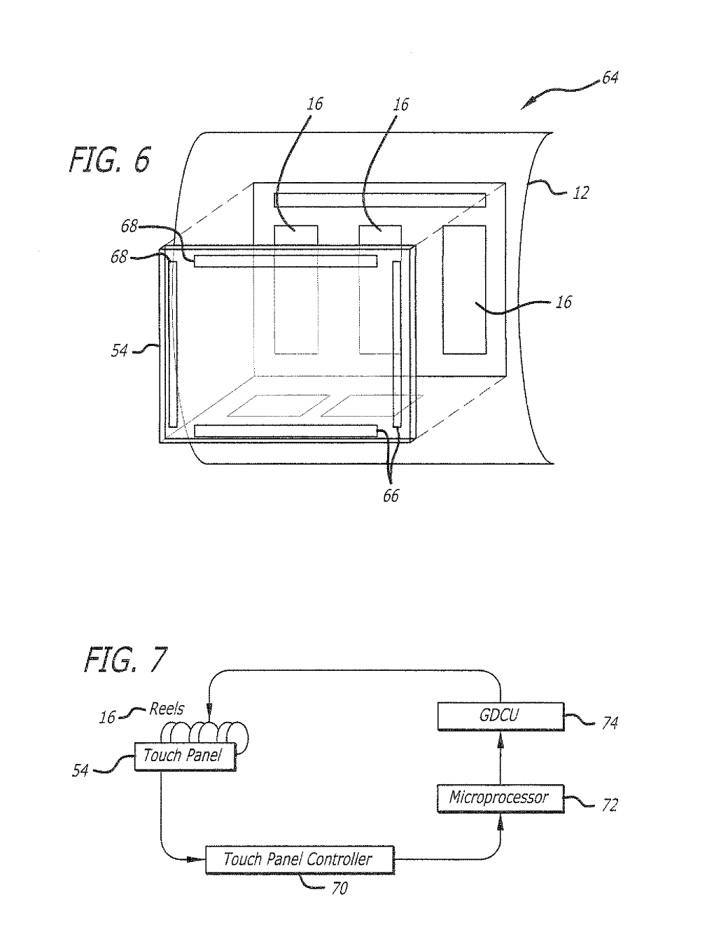

FIGS. 6-8 illustrate one embodiment of a touch sensor assembly 68 incorporating a substantially transparent touch panel 54, a touch controller 70, and touch panel software. As shown in FIG. 6, the touch panel 54 utilizes the touch sensor assembly 68 to produce touch data when touched or activated, as well as allowing substantially unobstructed viewing of the projected images of the reels shown on the curved display 12 behind the touch panel. The touch sensor assembly 68 includes one or more touch pad areas (not shown), one or more touch transducers 66, wave reflectors (not shown), cabling (not shown), a bezel (not shown), a touch panel controller 70, touch panel driver software, and touch panel application software. The material for the touch pad areas (not shown), is either glass or other polymeric material suitable for propagating surface acoustic waves.

Additionally, the transducers 66 are able to adhere to the skin of the glass-like materials of the touch panel 54 sufficiently to pass around curves. This allows a curved touch panel (not shown) to be utilized without detrimental effects. Accordingly, in one embodiment, the touch panel 54 has a radius of curvature similar to the curved display 12. Also, one of ordinary skill in the art will appreciate that while the touch panel 54 is shown to be rectangular in shape with respect to FIG. 6, the touch panel may be designed to accommodate the shape of any gaming machine configuration (e.g., circle, semi-circle, triangle, and the like).

As shown in FIG. 7, the touch panel 54 is placed in front the projected images of the reels 16. Touch panel data received by the touch panel 54 is transmitted to the touch panel controller. The touch panel controller 70 acts to control and interpret touch data from the touch panel 54. The controller 70 typically includes a printed circuit board assembly, often encased inside a metal or plastic housing with mounting holes. In one embodiment, the controller 70 is mounted to the inside of the gaming machine door or cabinet, and is preferably within reach of the touch panel wiring (not shown). The controller 70 is wired to the appropriate power and communication connections within the gaming machine. The controller 70 outputs a data stream consisting of touch coordinate information.

In one embodiment, the microprocessor 72 runs an application that translates the touch panel controller 70 serial touch information into reel control commands for the GDCU reel controller 74. The application uses drivers to communicate with the GDCU 74 which controls the projection of the image onto the curved display 12. The GDCU 74 is a communications portion of the gaming device 10 which “talks” to the different components of the gaming device.

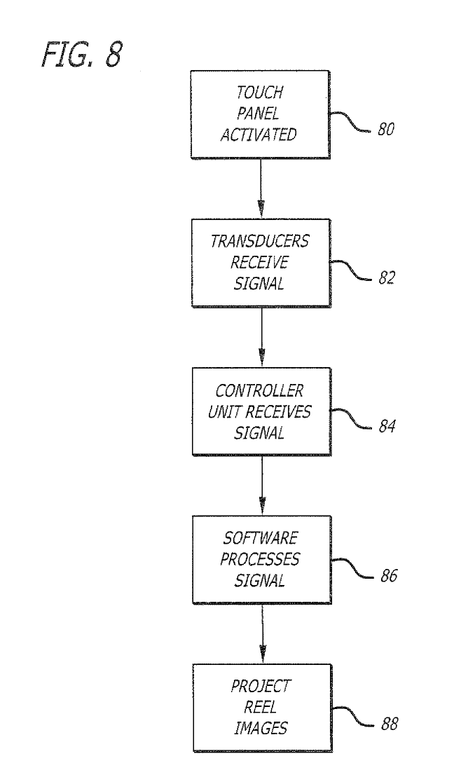

FIG. 8 illustrates the operational flow of a gaming device 10 including a touch panel system. As shown in FIG. 8, the logical operations of the various embodiments of the touch screen system are implemented (1) as a sequence of computer implemented steps or program modules running on a computing system and/or (2) as interconnected machine logic circuits or circuit modules within the computing system. The implementation is a matter of choice dependent on the performance requirements of the computing system implementing the touch panel system. Accordingly, the logical operations making up the embodiments of the touch panel system described herein are referred to variously as operations, structural devices, acts or modules. It will be recognized by one skilled in the art that these operations, structural devices, acts and modules may be implemented in the system, in firmware, in special purpose logic, analog circuitry, or any combination thereof.

As shown in FIG. 8, the logical operations of a touch panel system 64 utilize the components of the system in a logical sequence. In the panel activation step 80, the touch panel 54 is activated. This occurrence produces a signal that is received by the transducers 66 associated with the touch panel 54 in the transducer signaling step 82. In the controller signaling step 84, a signal is sent to the touch panel controller 70 reporting the activation of the touch panel 54. From the touch panel controller 70, a signal is then sent to, and interpreted by, the touch panel software (which is in the microprocessor 70) in the signal processing step 86. Finally, the touch panel software sends a signal to the GDCU reel controller 74 to activate the DLP device 18 in the mechanical activation step 88.

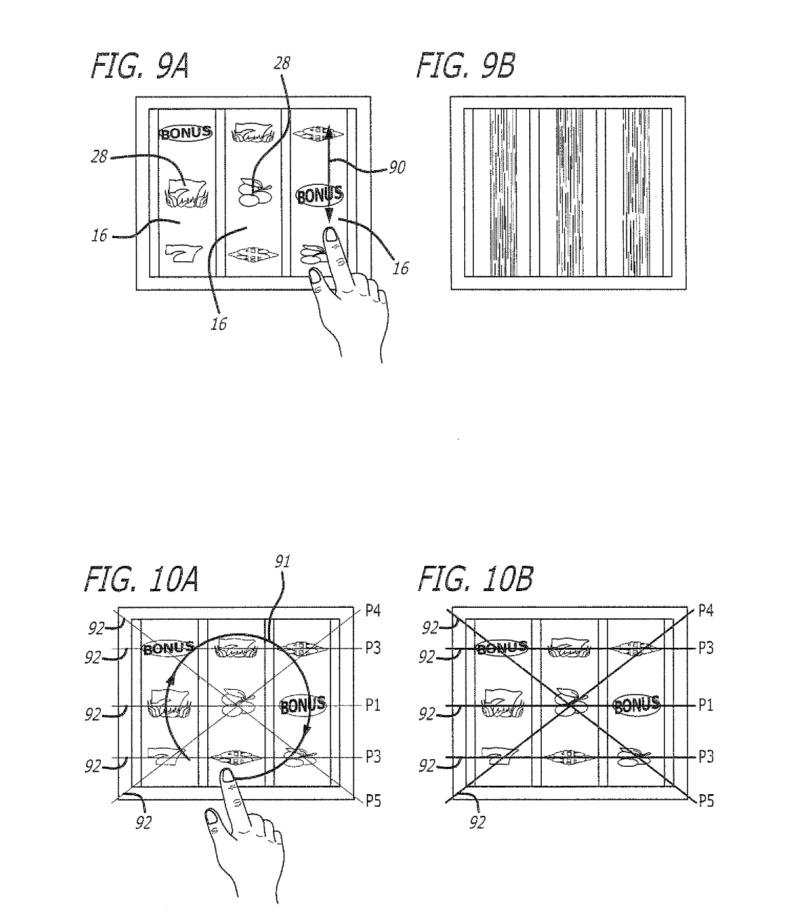

The touch panel system 64 is adapted to detect and interpret different types of touch data. For example, FIGS. 9A-9B illustrate one embodiment in which touch data in the form of a touch gesture 90 generally parallel to the reels will cause the projected image of the reels to spin. The touch gesture in a “slide up” or “slide down” motion will initiate the spinning of the reels as shown in FIG. 9B. The gesture causes the reels to spin in the particular direction of the gesture. For example, if the gesture moves top-down on the touch screen, the reels spin in a top-down direction. Alternatively, if the gesture 90 moves bottom-up on the touch screen, the reels spin in a bottom-up direction. Additionally, the speed of the gesture 90 may affect the speed of the spinning of the reels. For example, if the gesture 90 is fast, the reels spin fast whereas the reels will spin slower for a slower gesture 90. Generally, any gesture 90 on the touch screen that is parallel to the image of the reels will cause all the reels to spin. In another embodiment, the player needs to make a gesture 90 at a particular area adjacent to the image of the reels in order to cause the image of the reels to spin. In yet another embodiment, the player can gesture to control each reel. Accordingly, the player may vary the order and/or speed of each reel spun.

FIGS. 10A-10B illustrates touch gestures related to placing a wager or selecting a pay line. For example, in one embodiment, touch data sensed at the location near a pay line will result in the selection of the pay line for play. If the touch data is a circular motion 91 that covers one or more paylines 92, this touch gesture is interpreted as selecting two or more pay lines, as shown in FIG. 10A. For example, the circular gesture encompasses or touches all pay lines, and then all the pay lines are selected. Alternatively, if the circular gesture only encompasses three pay lines, those three pay lines are selected for play. As shown in FIG. 10B, the pay lines located within the touch gesture are highlighted on the screen and active for game play.

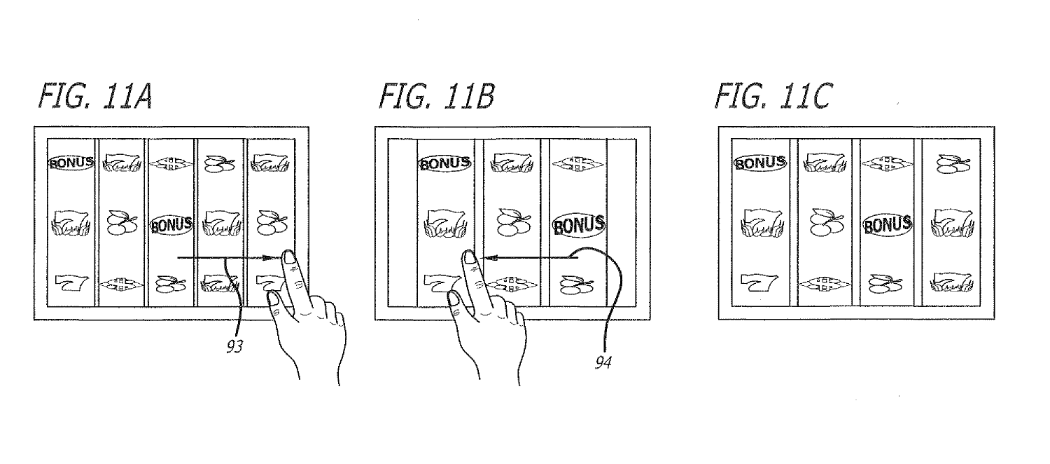

FIGS. 11A-11C illustrates various screen shots of touch gestures that add or remove reels from the game. A generally-perpendicular, touch gesture 93 in a direction away from the reels is interpreted as a player request to remove reels. FIG. 11A shows a five-reel game and a player touch gesture 93 (away from the reels toward the edge of the screen). As a result, two reels are removed from the game, and the curved display projects an image of a three-reel game as shown in FIG. 11B. According to one embodiment, each generally perpendicular touch gesture in a direction away from the reels causes one reel to be removed. In another embodiment, each generally perpendicular touch gesture causes a predetermined number of reels (e.g., two reels) to be removed from the game. As those skilled in the art will appreciate, the game is configured to have a predetermined minimum number of reels for a particular game.

As shown in FIG. 11B, a generally-perpendicular touch gesture 94 from the edge/side of the curved display toward the center of the display causes one or more reels to be added to the game. As shown in FIG. 11C, the touch gesture 94 of FIG. 11B causes one reel to be added to the game to form a four-reel game. A gesture 93, 94 may be programmed to add one reel or add a predefined group of reels (e.g., two, three, or more reels per gesture).

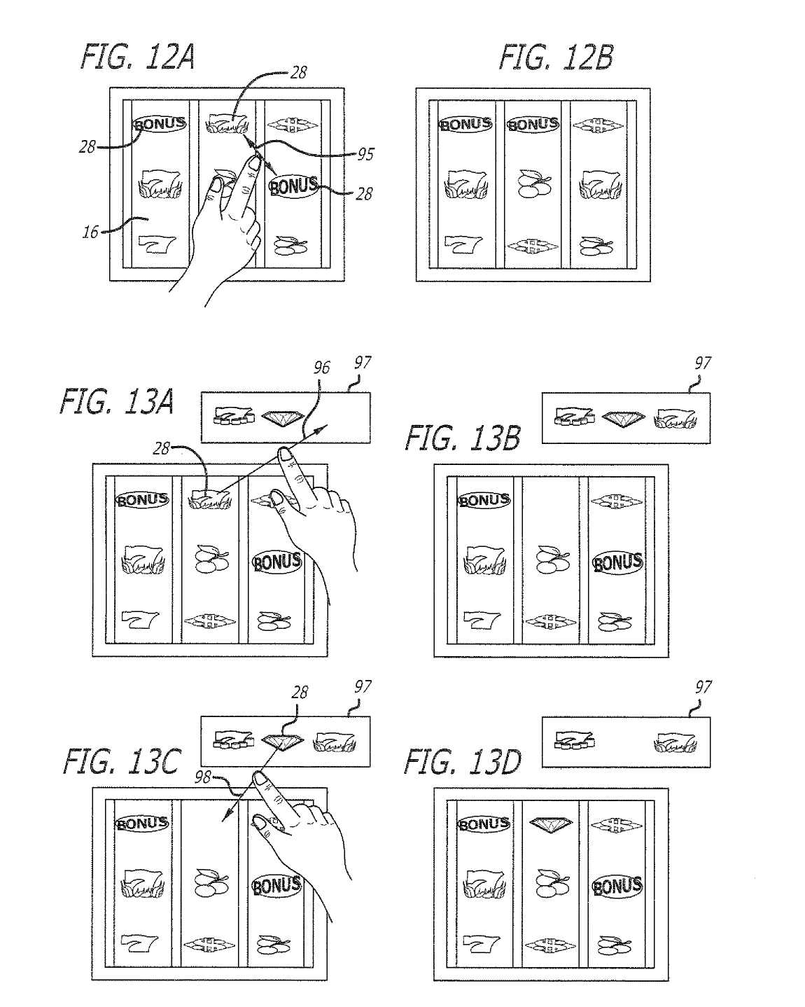

FIGS. 12A-12B illustrates another embodiment of touch gestures 95 that allow a player to move symbols 28 between reels 16. As shown in FIG. 12A, the gesture is touching the positions on the touch screen corresponding to two game indicia (e.g., with the thumb and middle finger) and drawing the thumb and middle finger together. This gesture will cause two symbols to swap positions on the reels as shown in FIG. 12B.

As shown in FIGS. 12A-12B, a player is able to swap symbols between adjacent reels. Alternatively, the player may be able to swap symbols between non-adjacent reels. In another embodiment, the touch data may be a gesture that allows a player to change the order of symbols on the same reel. In one embodiment, only adjacent symbols on the same reel may be swapped. Alternatively, any symbols on the same reel may be swapped. The touch screen may be activated during certain portions of a game to allow a player to swap symbols. For example, the touch screen may be activated for a predetermined period of time after a game has completed. Accordingly, a player may attempt to achieve a winning outcome or improve a winning outcome by swapping symbols.

In various embodiments, the ability to swap symbols may be a feature of the game or the player must have satisfied some predefined criteria to permit this feature of the game. For example, the predefined criteria may be one or more maximum wagers, a predefined period of continuous play, a particular player club level, accrual of a particular number of player club points, or any other trigger events known or developed in the art. As those skilled in the art will appreciate, the game may be limited to only allow the player to swap certain game indicia. Alternatively, the game may allow any swapping of game indicia between reels or on the same reel. Optionally, the game may allow more than one swap per game.

In yet another embodiment, the touch screen is configured to accept touch data that allows a player to add a game indicia onto one or more reels or remove one or more indicia from a reel as shown in FIGS. 13A-13D. FIG. 13A illustrate one embodiment in which a touch gesture 96 from a game indicia 28 on one of the reels to a symbol bank 97 causes the game indicia to be moved from the reel to the symbol bank as shown in FIG. 13B. FIG. 13C illustrates one embodiment in which a touch gesture 98 from a symbol bank 97 to a reel 16 causes a game indicia 28 to be added to a reel at the position in which the touch gesture terminates, as shown in FIG. 13D. In another embodiment, the game indicia 28 may be randomly added to a reel. Generally, the game indicia 28 are added or removed prior to game play or after a game has ended. Optionally, the game indicia 28 may be added while the reels are spinning. The touch screen may be activated to allow such gestures in response to a wager, game outcome, some player characteristic, or a trigger event.

In another embodiment, the touch screen is configured to accept touch data that allows a player to define a pay line. Accordingly, a player may drag a finger across the screen to connect a number of positions on one or more reels to form a pay line. For example, in a three-reel game having three pay lines (i.e., display shows three symbols on each reel), the player may define a pay line that is composed of two symbol positions on the first reel and one symbol position on the second reel. These symbol positions are generally composed of three adjacent symbol positions. Alternatively, the pay line is composed of three non-adjacent symbol positions. In another embodiment, the pay line may be composed of merely three symbol positions on any number of the reels. As those skilled in the art will appreciate, a five-reel game having a touch screen may allow a player-defined pay lines.

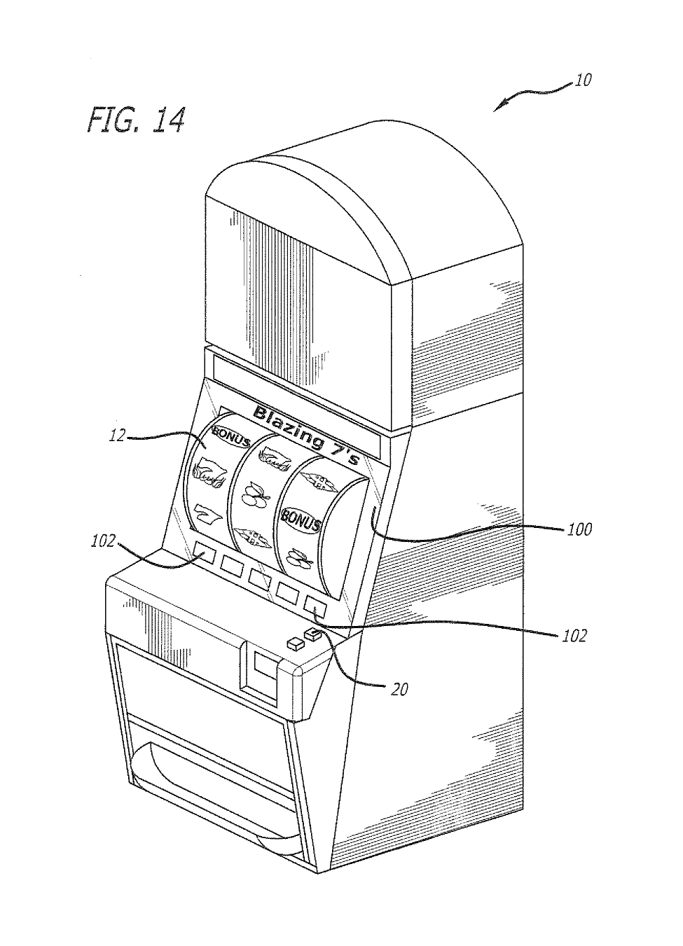

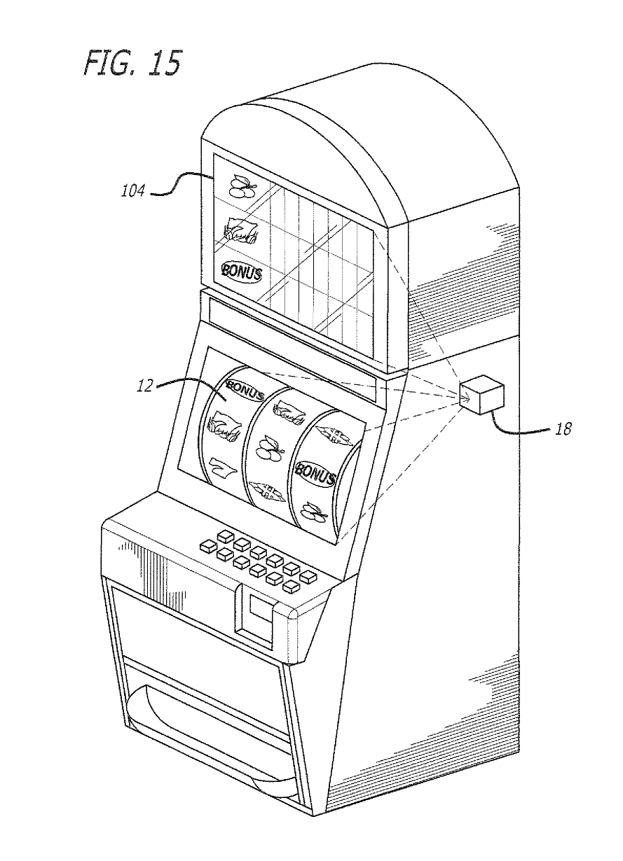

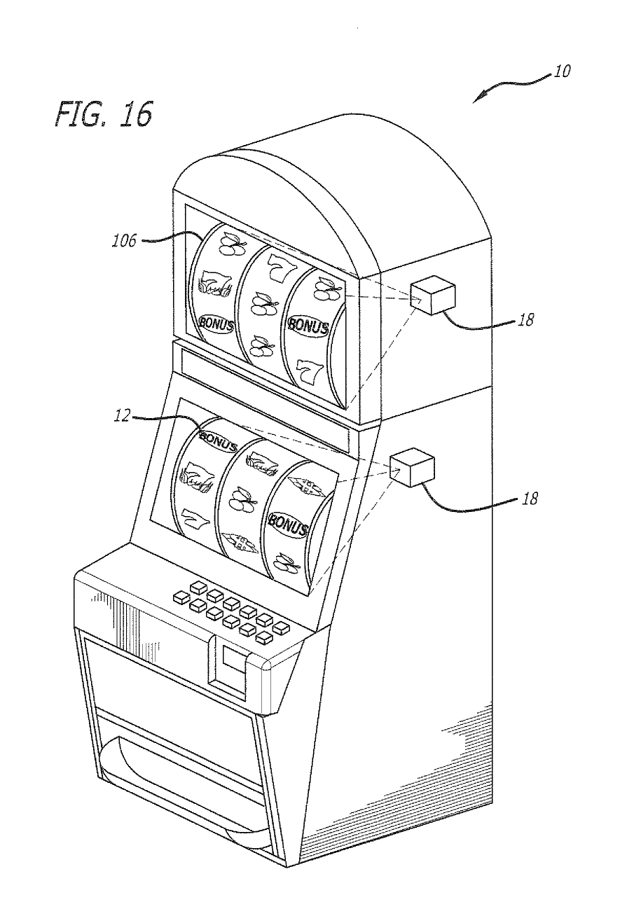

FIG. 14 illustrates another embodiment of a gaming device 10 having a curved display 12 and a LCD 100. Generally, the LCD 100 is a flat panel display, but the LCD 100 may be curved (e.g., concave, convex, or a combination thereof). As shown in FIG. 14, the LCD 100 includes an opening sized to allow at least a portion of the curved display 12 to protrude through the opening. As shown in FIG. 14, the entire curved display 12 is protruding through the opening of the LCD 100. In another embodiment, the opening of the LCD 100 is sized to allow only a portion of the curved display 12 to protrude through the opening. In yet another embodiment, the curved display 12 is positioned behind the opening of the LCD 100.

The LCD 100 may present gaming and non-gaming related information. The gaming information may include, but is not limited to, available credits, credits wagered, credits wagered per pay line, active pay lines, win meter, wager denomination, indicia representing selected pay lines, maximum bet amount, amount wagered, or any combination thereof. Other gaming information includes, but is not limited to, game instructions one or more help menus, one or more pay tables, jackpot or progressive jackpot or game information, tournament game information, community gaming information, notification of a bonus game, number of bonus points, animation, images (e.g., still or video), or other features related to game play or the game theme.

In addition to gaming information, the LCD 100 may present non-gaming information during or prior to the game (e.g., during an attract mode). The LCD 100 may present either still images, video images, or graphics related to the game title or game theme. Optionally, the LCD 100 may present information not related to the game such as, but not limited to, player tracking account information, advertisements, a news ticker, sports ticker, safety information (e.g., warnings regarding responsible gaming, fire alarms, or the like), or status of a drink and/or food order.

In yet another embodiment, the LCD 100 may present a player interface having one or more images of buttons 102. The buttons 102 may be related to game play (e.g., spin reels or activate a bonus game) or wagering activities such as, but not limited to, selecting a wager denomination, selecting a wager amount, placing a maximum bet, placing a minimum bet, or cashing out remaining credits.

In another embodiment, the LCD 100 of FIG. 14 is substituted with a display screen having a similar shape (i.e., display with an opening). Alternatively, the curved display and the display screen are integral. The display screen may present both gaming and non-gaming information. This information is presented on the display screen using a DLP device. In one embodiment, a single DLP device 18 is used to present the information on the display screen and the game on the curved display. Alternatively, one or more DLP devices 18 may be is used to present the information on the display screen and the curved display 12.

FIG. 15 illustrates one embodiment of a gaming device 10 having a curved display 12 and a secondary display screen 104 positioned above the curved display. In one embodiment, the secondary display screen 104 is a LCD, plasma, CRT, or other display device such as, but not limited to, one or more reels or wheels. In another embodiment, the secondary display 104 is a DLP display screen. In one embodiment, a single DLP device is used to project images on the curved display and the secondary display, as shown in FIG. 15. Alternatively, the curved display 12 and the secondary display 104 have dedicated DLP devices.

FIG. 16 illustrates another embodiment of a gaming device 10 having a curved display 12 that is used both a primary display and a secondary display 106. In one embodiment, a single DLP device 18 is used to project still and video images onto both the curved display 12 and the secondary display 106. As shown in FIG. 16, each curved display 12, 106 has a dedicated DLP device 18.

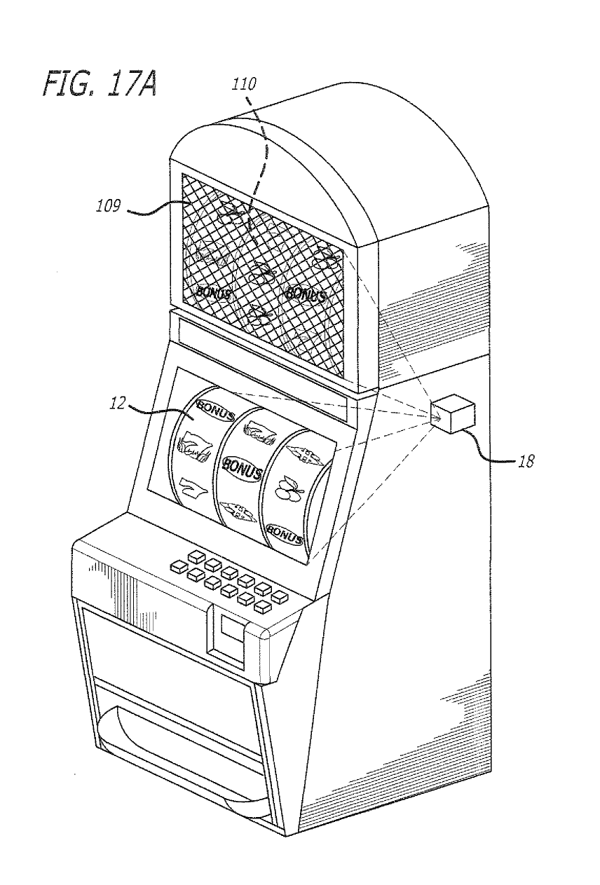

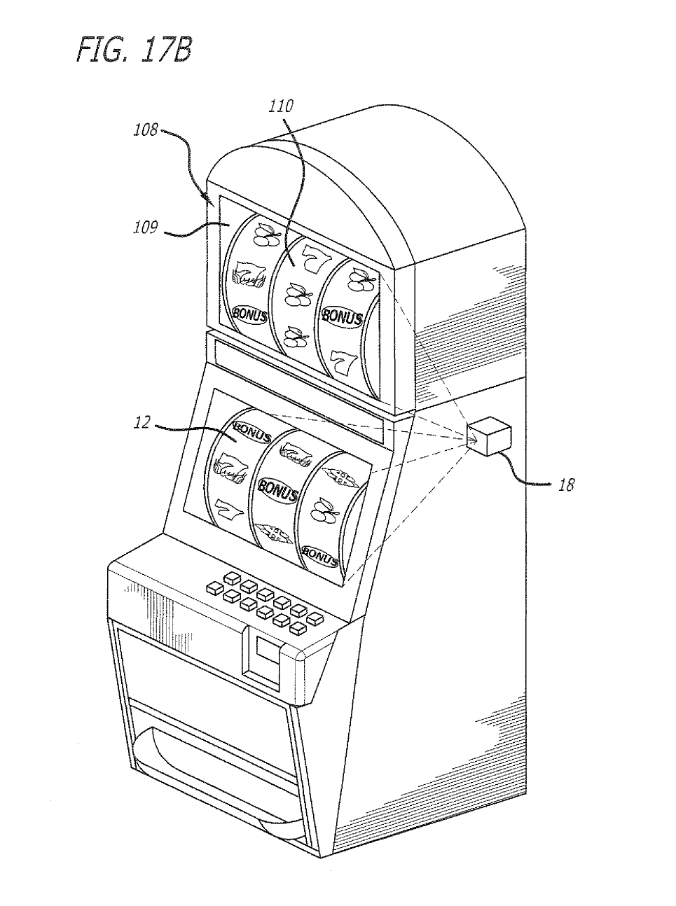

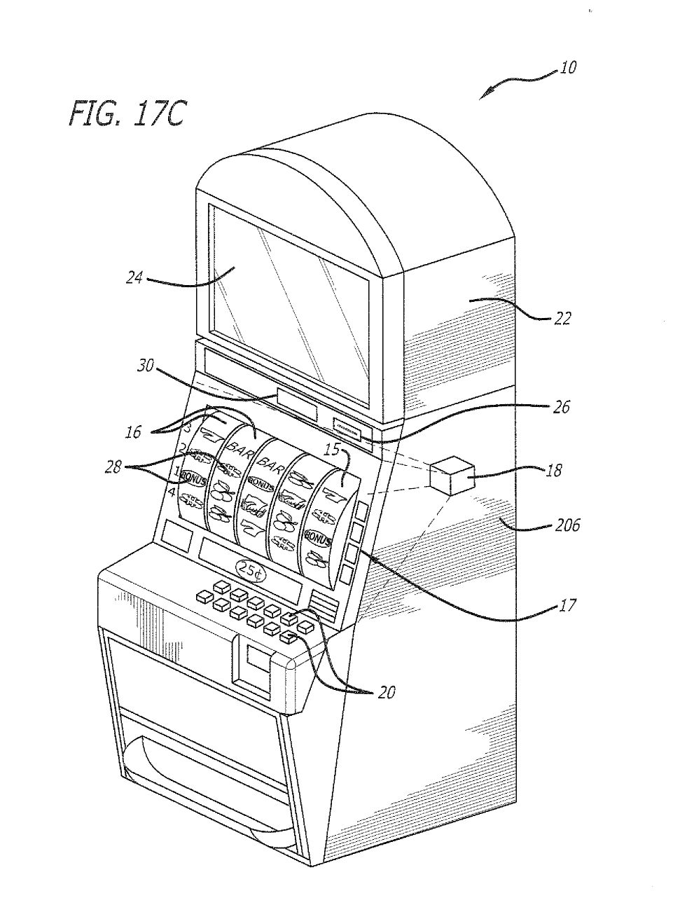

FIGS. 17A-17B illustrates another embodiment of a gaming device 10 having a curved display 12 and a secondary display 108. The secondary display 108 is composed of a LCD 109 that is placed in front of a secondary curved display 110. As shown in FIG. 17A, the LCD 109 obscures the secondary curved display 110. The LCD 109 may present a bonus game, game-related information, or non-game related information. As shown in FIG. 17B, the LCD 109 is transmissive such that the secondary curved display 110 is visible to the game patron. In some embodiments, the polarizers associated with the LCD 109 may be removed from the LCD as some LED projectors are not powerful enough to overcome the polarizers in the LCD.

FIG. 17C illustrates another embodiment of a gaming device 10 having a moulded main display. The moulded main display has a curved main portion 15 and flat surfaces 17 positioned around the perimeter of the curved main portion 15. The flat surfaces 17 present game information such as, but not limited to, payline information (e.g., active/inactive paylines, wager per payline, payline number), game instructions, possible wager denominations, selected wager denomination, total credits won, total credits wagered, credits remaining, graphics, game title banners, images and/or video clips related to the game and/or game theme, or any combination thereof. In this embodiment, a single DLP device 18 projects the game onto the curved screen 15 and the game information onto the flat surfaces 17.

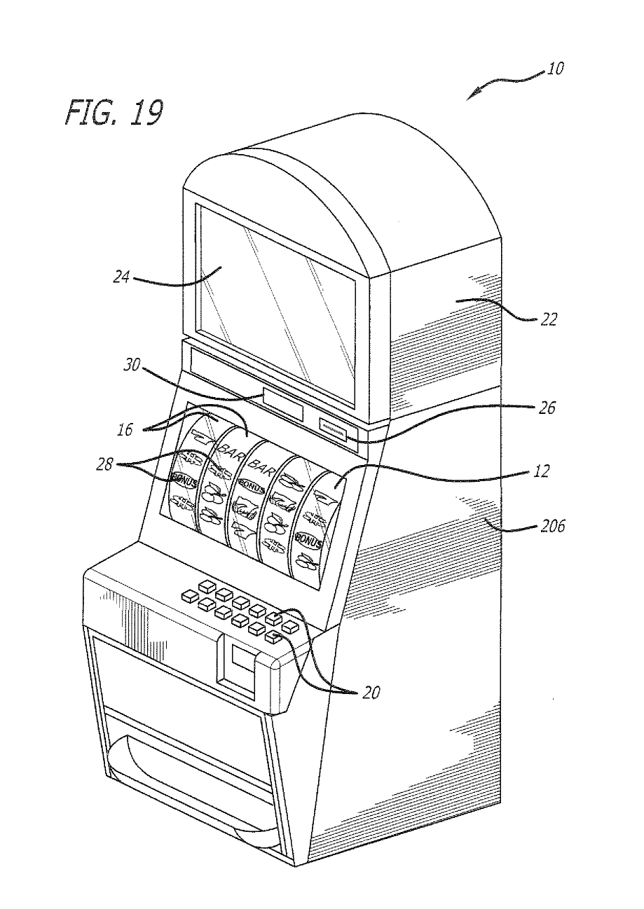

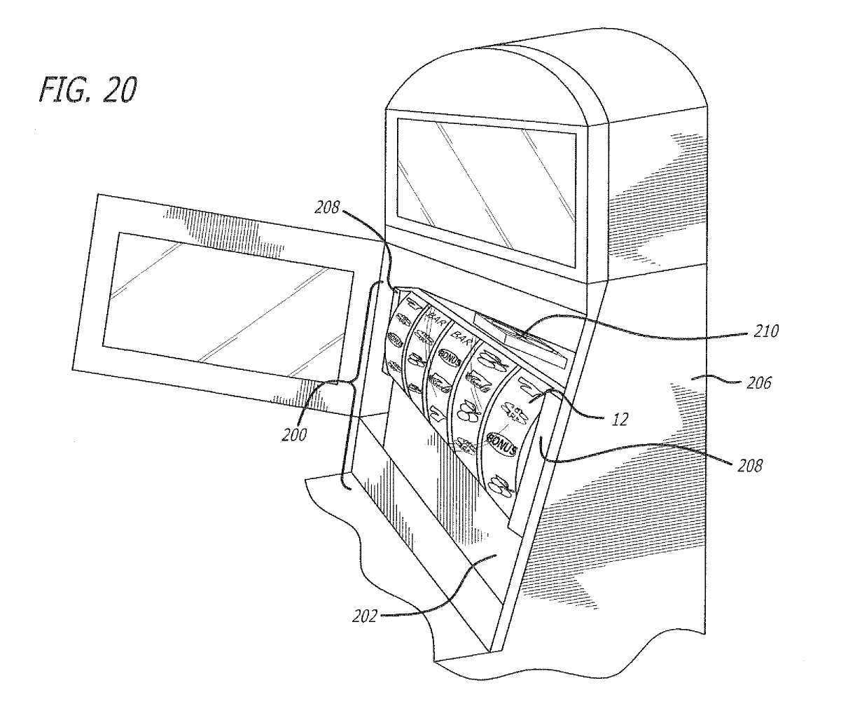

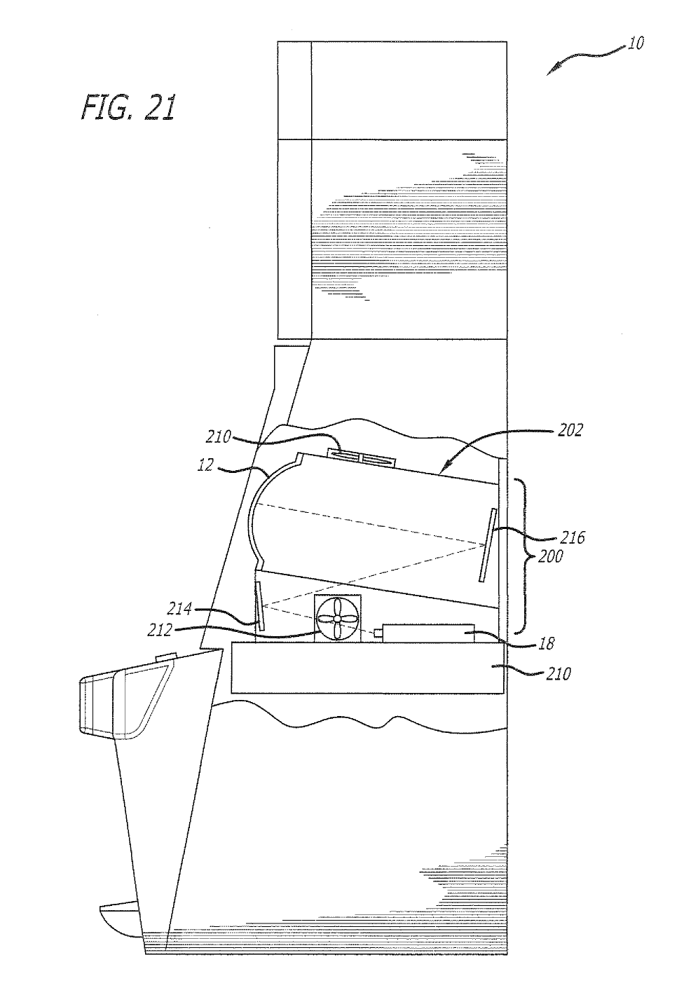

FIGS. 19-21 illustrate one embodiment of a self-contained projection system 200 that includes a curved display 12 and the associated projection components. The self-contained projection system 200 includes an enclosure 202 that is sealed to prevent dirt, dust and debris from contaminating the interior of the enclosure because any contaminants will adversely affect the light path (i.e., the path of light from the projector lens to the mirrors and to the curved material). The enclosure 202 may have one more walls 204 in combination with the curved material 12 to provide a sealed housing. As shown in FIGS. 20-21, the curved material 12 is coupled to the front of the enclosure 202. The interior of the enclosure 202 of the projection system 200 may include a light absorbing coating to absorb any stray or additional light rays from the projection source. The light absorbing coating may be black paint, powder coating, or a black texture coat.

Optionally, an aperture (not shown) may also be positioned in front of the projection source (or within the lens of the projection source) to reduce any stray light from reflecting within the enclosure. The aperture may be flat material having one or more openings corresponding to the images being projected onto the curved display.

The self-contained projection system 200 is mounted within a gaming cabinet 206 by brackets 208 provided on the sides of the enclosure 202, as shown in FIG. 20. The brackets 208 include openings and/or recesses for coupling the bracket 208 to the sides of the gaming cabinet 206. The inner surface of the brackets 208 also includes a recessed curved groove (not shown) sized and shaped to accommodate the curved material 12. In another embodiment, the enclosure 202 is positioned on top of a shelf 210 or other horizontal platform provided within the cabinet 206. In yet another embodiment, the self-contained system 200 is coupled to the sides of the gaming cabinet 206 and rests on a platform 210, as shown in FIG. 21. Optionally, one or more shock absorbers (e.g., bushings, gaskets, springs) may be placed between the self-contained system 200 and the gaming cabinet to isolate the system from any jarring forces or shock impulses.

Because the self-contained projection system 200 is sealed, one or more fans or heat pumps are provided to remove heat from the enclosure 202. For example, a fan 212 is provided at the top of the enclosure 202, and a fan 212 is provided near the DLP projector as shown in FIG. 21.

In FIG. 21, a DLP projector 18 is placed at the base of the enclosure 202. A cradle (not shown) fixes the DLP device 18 to the base of the enclosure 202 in order to ensure proper calibration of the projection system. The cradle (not shown) may be one or more brackets, jigs, and/or mounts cast, molded, or bolted to the base of the enclosure.

As shown in FIG. 21, a mirror 214 is placed at the front of the enclosure 202 near the base of the enclosure, and another mirror 216 is placed at the back of the enclosure 202 near the top of the enclosure. The mirrors 214, 216 are front glass mirrors or any other mirrors known or developed in the art that substantially reflects the image projected onto the mirror. The mirrors 214, 216 are substantially flat and generally rectangular in shape. According to one embodiment, the lower mirror 214 is smaller in size as compared to the upper mirror 216.

The lower mirror 214 is angled such that the bottom of the mirror is further away from the front of the enclosure 202 as compared to the top of the mirror. Similarly, the upper mirror 216 is angled so that the bottom of the mirror is closer to the front of the enclosure as compared to the top of the mirror. That is, the lower and upper mirrors 214, 216 are angled to reflect the projected image upwards and ultimately to the curved material 12. The mirrors 214, 216 reduce the overall depth of the enclosure 202 by dividing the light path. In other embodiments, the mirrors may be angled in any direction or at any angle to ensure that the projected image is reflected onto the curved material.

In one embodiment, the mirrors 214, 216 are attached to a hinge (not shown) in order to adjust the angle of the mirrors. In another embodiment, a remotely controlled motor (not shown) is coupled to the mirrors 214, 216 by a force transmission member (not shown) in order to adjusts the angle of the mirrors 214, 216. In yet another embodiment, one or more shims are used to adjust and fix the position of the mirrors. In another embodiment, the lower mirror 214 is adjustable and the upper mirror 216 is mounted at a fixed angle. Alternatively, the lower mirror 214 is fixed and the upper mirror 216 is adjustable. Optionally, the angle of the mirrors 214, 216 may also be adjusted by a laser alignment process. A laser is used during the assembly process to ensure that the optical path is properly aligned and calibrated.

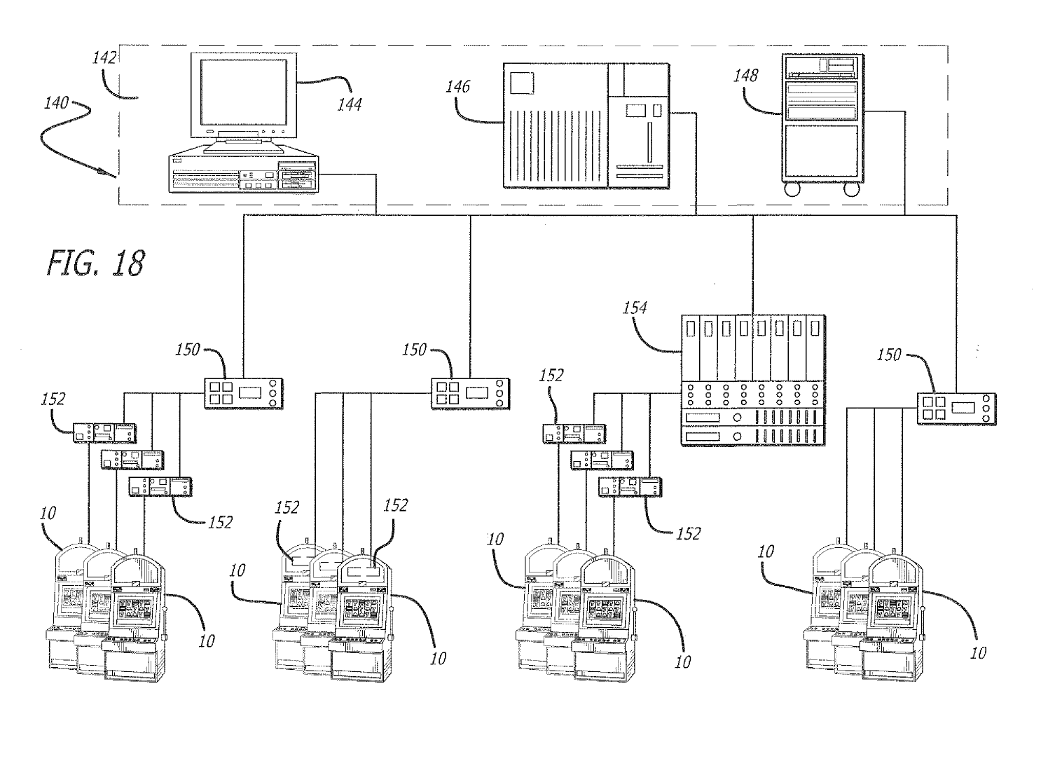

FIG. 18 illustrates a casino gaming system that may include one or more gaming devices 10 that have a curved display. The casino gaming system 140 comprises one or more gaming devices 10. The gaming devices 10 illustrated in FIG. 18 act as terminals devices for interacting with a player playing a casino game. Networking components facilitate communications between a backend system 142 and game management units 152 that control displays for carousels of gaming devices 10 across a network. Game management units (GMU's) 152 connect gaming devices 10 to networking components and may be installed in the gaming machine cabinet or external to the gaming device 10. The function of the GMU 152 is similar to the function of a network interface card connected to a desktop personal computer (PC). Some GMU's 152 have much greater capability and can perform such tasks as presenting and playing a game using a display (not shown) operatively connected to the GMU 152. In one embodiment, the GMU 152 is a separate component located outside the gaming device 10. Alternatively, in another embodiment, the GMU 152 is located within the gaming device 10. Optionally, in an alternative embodiment, one or more gaming devices 10 connect directly to a network and are not connected to a GMU 152.

The gaming devices 10 are connected via a network to a network bridge 150, which is used for networking, routing and polling gaming devices, including slot machines. The network bridge 150 connects to a back end system 142. Optionally, the gaming devices 10 may connect to the network via a network rack 154, which provides for a few numbers of connections to the back end system 142. Both, network bridge 150 and network rack 154 may be classified as middleware, and facilitate communications between the back end system 142 and the GMUs 152. The network bridges 150 and network rack 154 may comprise data repositories for storing network performance data. Such performance data may be based on network traffic and other network related information. Optionally, the network bridge 150 and the network rack 154 may be interchangeable components. For example, in one embodiment, a casino gaming system may comprise only network bridges and no network racks. Alternatively, in another embodiment, a casino gaming system may comprise only network racks and no network bridges. Additionally, in an alternative embodiment, a casino gaming system may comprise any combination of one or more network bridges and one or more network racks.

The back end system 142 may be configured to comprise one or more servers. The type of server employed is generally determined by the platform and software requirements of the gaming system. In one embodiment, as illustrated in FIG. 18, the back end system 142 is configured to include three servers: a slot floor controller 144, a casino management server 146 and a casino database 148. The slot floor controller 144 is a part of the player tracking system for gathering accounting, security and player specific information. The casino management server 146 and casino database 148 work together to store and process information specific to both employees and players. Player specific information includes, but is not limited to, passwords, biometric identification, player card identification, and biographic data. Additionally, employee specification information may include biographic data, biometric information, job level and rank, passwords, authorization codes and security clearance levels.

Overall, the back end system 142 performs several functions. For example, the back end system 142 can collect data from the slot floor as communicated to it from other network components, and maintain the collected data in its database. The back end system 142 may use slot floor data to generate a report used in casino operation functions. Examples of such reports include, but are not limited to, accounting reports, security reports, and usage reports. The back end system 142 may also pass data to another server for other functions. Alternatively, the back end system 142 may pass data stored on its database to floor hardware for interaction with a game or game player. For example, data such as a game player's name or the amount of a ticket being redeemed at a game may be passed to the floor hardware. Additionally, the back end system 142 may comprise one or more data repositories for storing data. Examples of types of data stored in the system server data repositories include, but are not limited to, information relating to individual player play data, individual game accounting data, gaming machine accounting data, cashable ticket data, sound data, and optimal display configurations for one or more displays for one or more system game.

Of course, one will appreciate that a gaming system 140 may also comprise other types of components, and the above illustrations are meant only as examples and not as limitations to the types of components or games used in a casino gaming system.

Referring back to FIG. 1, the gaming device 10 includes a plurality of player-activated buttons 20 used for various functions such as, but not limited to, selecting a wager denomination, selecting a number of games to be played, selecting the wager amount per game, initiating a game, or cashing out money from the gaming machine 10. In various embodiments, the player-activated buttons 20 functions are, but are not limited to, mechanical buttons, electromechanical buttons, touch screen buttons, or soft key buttons. According to one embodiment, the buttons 20 are backlit to indicate whether the button is active.

In another embodiment, the player-activated button is a universal button module that provides a dynamic button system adaptable for use with various games, as disclosed in U.S. application Ser. No. 11/106,212, entitled “Universal Button Module”, filed Apr. 14, 2005 and U.S. application Ser. No. 11/223,364, entitled “Universal Button Module”, filed Sep. 9, 2005, which are both hereby incorporated herein by reference. In other embodiments, other input devices, such as but not limited to, touch pad, track ball, mouse, switches, and toggle switches, are included with the gaming machine to also accept player input.

In yet another embodiment, a cellular phone or other input device (e.g., PDA), separate and apart, from the gaming device 10 may also be used to input various player choices and information to enhance the player's interactive experience with the gaming machine. In this embodiment, the gaming machine 10 includes an IR sensor, RF sensor, BLUETOOTH receiver, or other means for receiving input from a cellular phone or other wireless input devices. Furthermore, inputting information via these devices provides an added level of security as any key presses may be hidden from view. In yet another embodiment, a player may call or send a text message or a short message service (SMS) to the gaming machine 10.

The main cabinet 14 of the gaming device 10 is a self-standing unit that is generally rectangular in shape. In another embodiment, the main cabinet is a slant-top gaming cabinet. Alternatively, in other embodiments, the gaming cabinet may be any shaped cabinet known or developed in the art that may include a top box. Additionally, the cabinet may be manufactured with reinforced steel or other rigid materials that are resistant to tampering and vandalism. Optionally, in an alternate embodiment, the gaming device is a cinema-style gaming device (not shown) having a widescreen display, as disclosed in U.S. application Ser. No. 11/225,827, entitled “Ergonomic Gaming Cabinet,” filed on Sep. 12, 2005, which is hereby incorporated herein by reference.

As shown in FIG. 1, the gaming device 10 includes a top box 22 and a cabinet main portion 15. According to one embodiment, the top box 22 is a separate and distinct component that is affixed to the main cabinet portion 15. In another embodiment, the top box 22 is an area that is partitioned from the main cabinet portion 15. Alternatively, the top box 22 and the main cabinet portion 15 may be contiguous areas with the outward appearance of two distinct components. In another embodiment, the top box 22 also includes a display glass (not shown) that includes the name of the game, artwork, game instructions, pay table, or other information relating to one or more games presented on the gaming device 10.

In another embodiment, the top box 18 includes the secondary display 24. The secondary display 24 presents game information (e.g., name of the game, animation, one or more pay tables, game information, one or more help menus, progressive jackpot or game information, tournament game information, or any combination thereof) or non-game related information (e.g., news, advertisements, messages, promotions, or any combination thereof). In another embodiment, the secondary display 24 presents a secondary game such as, but not limited to, a bonus game, a progressive game, or another game of chance such as, but not limited to, video slots, video keno, video poker, video blackjack, video roulette, Class II bingo, games of skill, games of chance involving some player skill, or any combination thereof.

In an alternative embodiment, the secondary display 24 presents game-related information such as, but not limited to, a pay table or one or more game options to the player. Alternately, the secondary display 24 presents non-game related information such as, but not limited to, advertisements, news, information on sports betting and betting options for those sporting events, requests for drinks or food, concierge services, or promotional information (e.g., information relating to player's club).

Optionally, the gaming device 10 also includes a third display 30 positioned above the curved material 12. As those skilled in the art will appreciate, the third display 30 may be positioned below the main display, adjacent to the primary or secondary display, on the player interface, or any location on the gaming device within the line-of-sight of a player. According to one embodiment, the third display 30 is a graphical interface, which is the subject of commonly owned U.S. patent application Ser. No. 10/943,771 titled “User Interface System and Method for a Gaming Machine”, filed Sep. 16, 2004, which is hereby incorporated herein by reference.

The graphical interface includes a web content capable display screen and an embedded processor. Preferably, the web content capable display screen presents web information to a user via the display screen. The embedded processor preferably utilizes an internal operating system and communicates with the gaming processor of the gaming device. Preferably, the embedded processor reads incoming data, translates the data into a web protocol (web authoring language), if necessary, and maps the data to the web content capable display screen. In this manner, the web content capable display screen increases user excitement by providing a richer gaming experience. Furthermore, the display allows the player to play a secondary game, input information, make selections, receive promotional information or other types of information including, but not limited to, notification that the player has won a system award, is entered into a tournament game or other bonus game. Additionally, the player is able to configure the attributes of interchanging display content via the graphical interface. In another embodiment, the content of the graphical interface may be presented on a portion of the main display 12 or as a pop-up window on the main display.

As shown in FIG. 1, the gaming device 10 includes a player tracking system interface. The player tracking system interface allows a casino to monitor the gaming activities of various players. Additionally, the player tracking system is able to store data relating to a player's gaming habits. That is, a player can accrue player points that depend upon the amount and frequency of their wagers. Casinos can use these player points to compensate the loyal patronage of players. For example, casinos may award or “comp” a player with free meals, room accommodations, tickets to shows, and invitations to casino events and promotional affairs. In one embodiment, the player's club level (e.g., Silver, Gold, Platinum), player rating, or total number of player points may qualify a player for a keno bonus round. In another embodiment, the player's club level adjusts the pay table for a keno game. Accordingly, a higher rated player wins more money for a given outcome as compared to a lower level (or unrated) player.

Typically, the player tracking system is operatively connected to one or more input components on the gaming device 10. These input components include, but are not limited to, a slot 26 for receiving a player tracking card, a keypad or equivalent, an electronic button receptor, a display, a touch screen, or the like. The player tracking system may also include a database of all qualified players (i.e., those players who have enrolled in a player rating or point accruing program). Generally, the database for the player tracking system is separate from the gaming machines. The iView® device sold by Bally technologies, Inc. of Las Vegas, Nev. is an example of a player tracking system interface.

The main cabinet 14 of the gaming device 10 also houses a game management unit (not shown) that includes a CPU, circuitry, and software for receiving signals from the player-activated buttons 20, operating the games, and transmitting signals to the respective game display 12, 24 and speakers.

In various embodiments, game program may be stored in a memory (not shown) comprising a read only memory (ROM), volatile or non-volatile random access memory (RAM), a hard drive or flash memory device or any of several alternative types of single or multiple memory devices or structures. Optionally, the gaming devices 10 include one or more data repositories for storing data. Examples of information stored by the gaming devices 10 include, but are not limited to, accounting data, maintenance history information, short and/or long-term play data, real-time play data, sound data, video data, or animation data.

As shown in FIG. 1, the gaming machine 10 includes a ticket reader/ticket printer slot 36 that is associated with a cashless gaming system (not shown). According to one embodiment, the slot 37 is used for the ticket reader and ticket printer. Accordingly, the same slot 36 may be used to insert and/or issue a ticket. However, in alternate embodiments, separate slots (not shown) may be provided for the ticket acceptor and the ticket printer. In one embodiment, the ticket reader (not shown) of the cashless gaming system is capable of accepting previously printed vouchers, paper currency, promotional coupons, or the like. The ticket printer (not shown) of the cashless gaming system generates vouchers having printed information that includes, but is not limited to, the value of the voucher (i.e., cash-out amount) and a barcode that identifies the voucher.

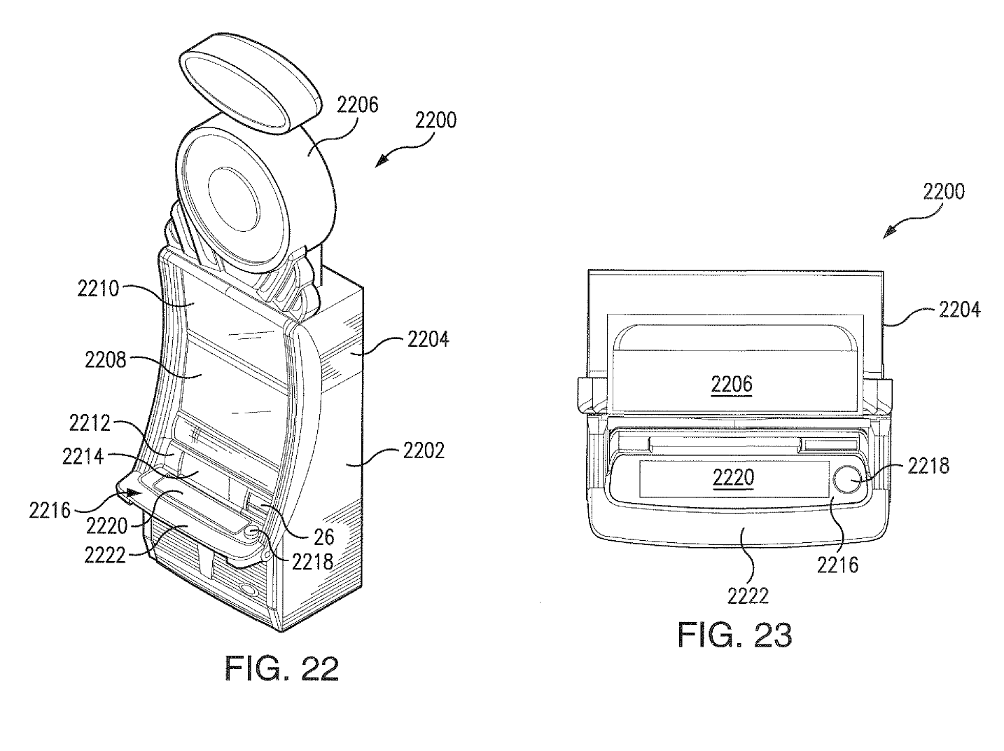

Turning now to FIGS. 22 and 23 there is an embodiment of a gaming device 2200 configured to include a player interface button according to the present invention. The gaming device 2200 includes a cabinet 2202 housing the various components. The cabinet 2202 includes a top box 2204 as well. A topper 2206 includes lights and backlit printed panels to attract players to the device 2200. The cabinet 2204 supports a main game display 22008 which may be a CRT, LCD, OLED or other electronic video display. Alternatively the main game display 2208 may be a window for viewing electro-mechanical stepper reels as is known in the art or backlit reels as described in the various embodiments previously described. The cabinet 2202 and more particularly the top box 2204 support a secondary display 2210. The secondary display 2210 may be a backlit printed glass or plastic panel or may be a display of the type described in reference to the main game display 2208. The main game display 2204 is positioned to display primary content to the player such as a game. The secondary display 2210 typically displays additional content such as information about the game, e.g. game name and associated graphics and pay table but may also display other content such as a bonus game or, in combination with the main game display 2208, a common game or bonus game display. It should be understood that the displays could display other content such as advertising, sports or other programming or the like.

The gaming device 2000 also includes a gaming system interface 2212 which has a display and the slot 26 for receiving and reading a player tracking card as described above.

A user interface 2216 is provided to enable the player to interact with the gaming device 2000. The interface 2216 includes one or more displaceable buttons 2218. As shown in FIGS. 22 and 22 the interface 2216 may include a touch screen panel 2220 to display gesture activated buttons (not shown) in addition to any displaceable buttons 2218. By a “displaceable” button 2218 what is meant is a mechanical button which can be physically displaced by sliding, rotating, rocking, depressing or the like to enter an interface input. As part of the interface 2216 or as a separate component a cushioned hand rest 2222 may also be provided.

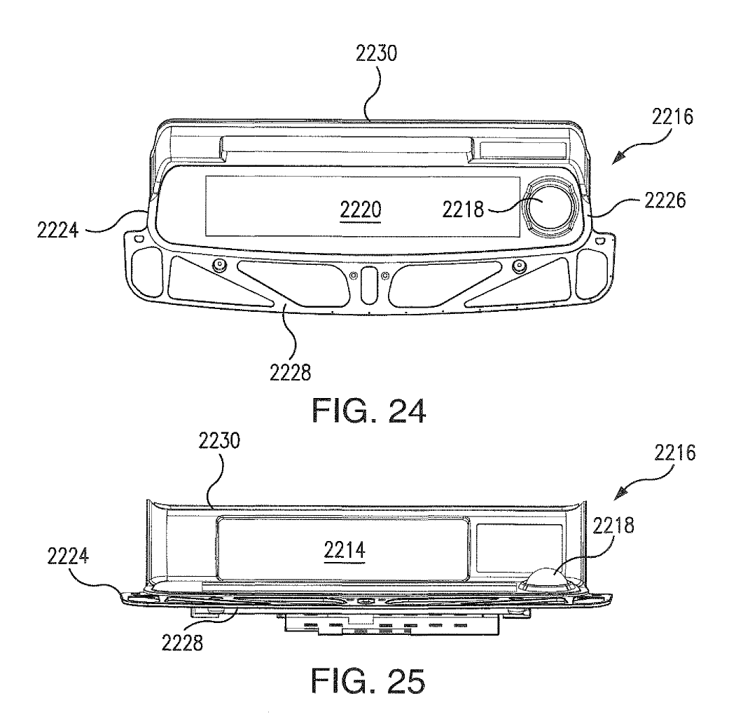

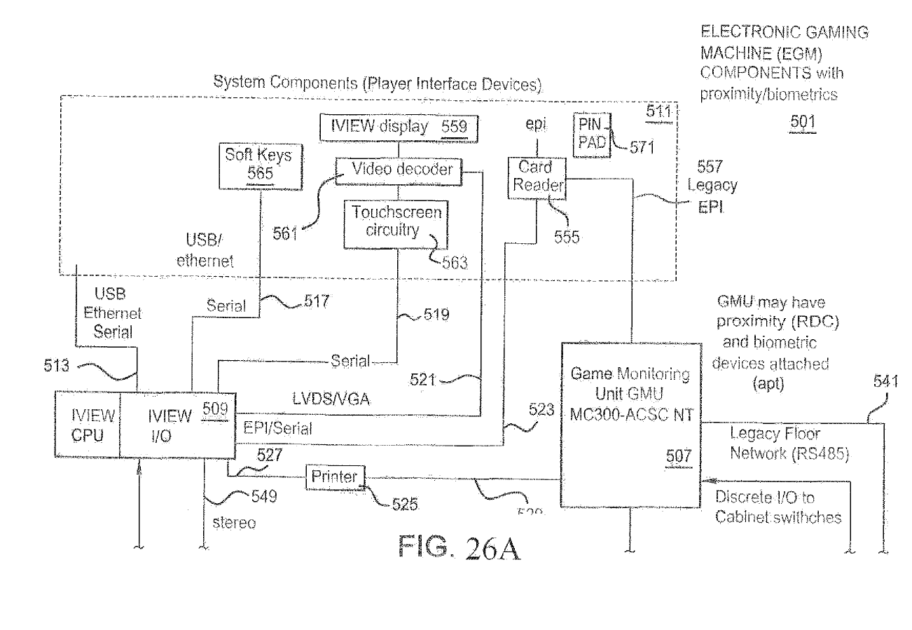

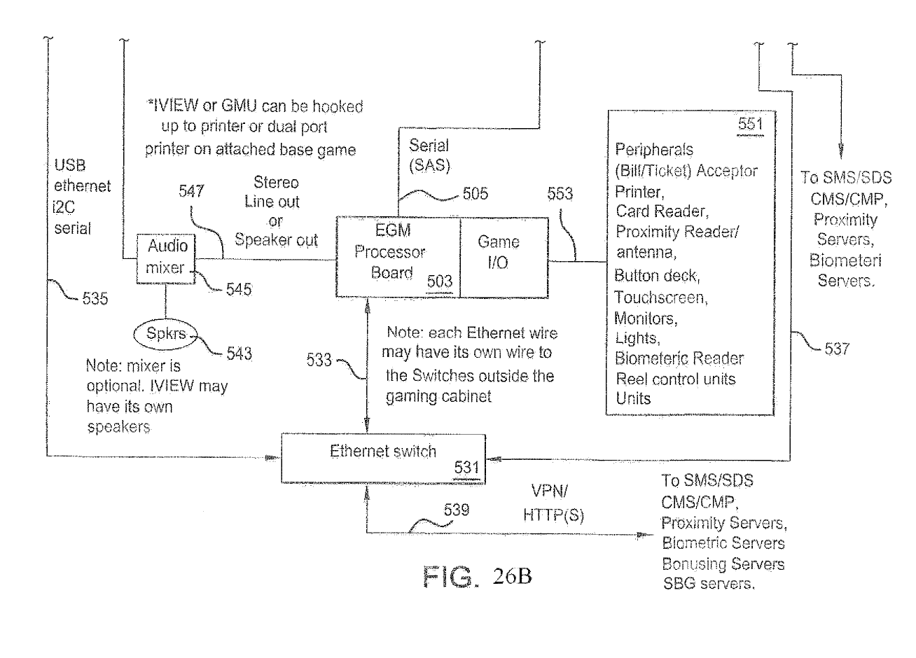

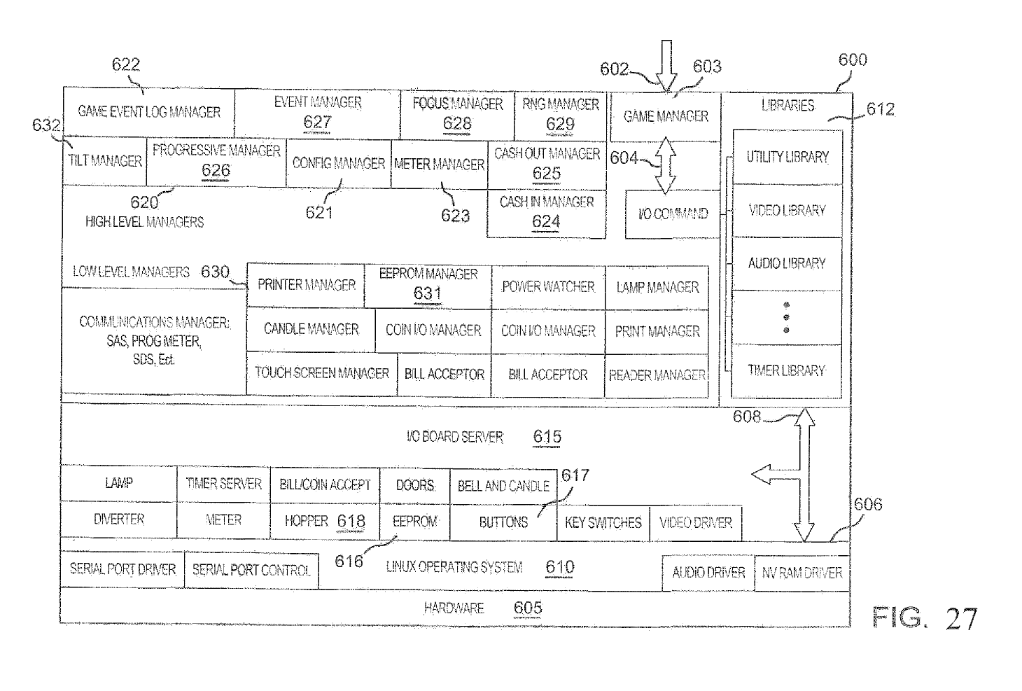

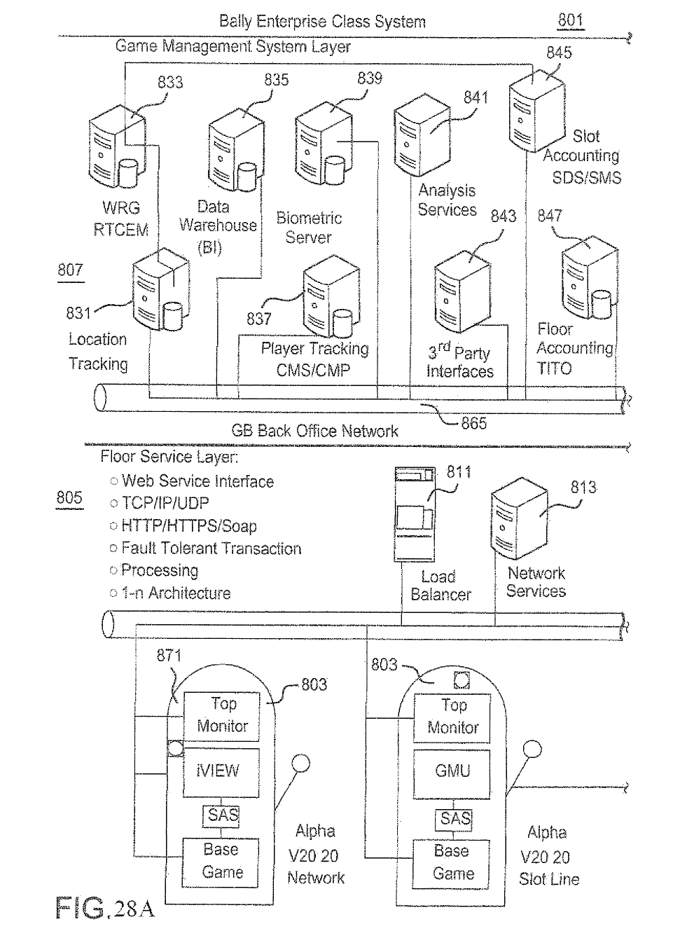

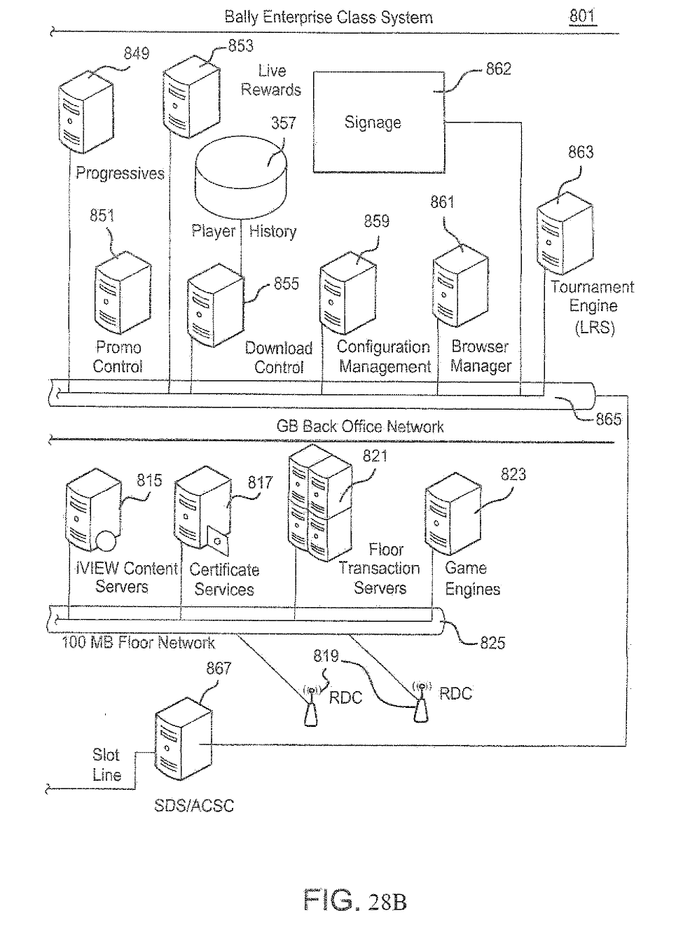

The player interface 2216 is configured to include a supporting substrate 2224 as shown in FIGS. 24 and 25. The substrate 2224 has a body 2226 supporting the touch screen panel 2220 and button 2218. Projecting from one side of the body 2226 is a hand rest frame 2228 to mount the hand rest 2222. Opposite the frame 2228 is an upstanding player tracking interface mount 2230 shaped to mount the components of the gaming system interface 2216 including the display 2214 and slot 26. The interface 2216 may be configured as an original equipment or it may be configured as a retrofit for existing gaming devices. Further it should be understood that the configuration of the interface 2216 would change depending upon the design of the gaming device 2200. Some gaming devices may be more narrow or may require that the gaming system interface be located elsewhere in the gaming device.

Turning to FIGS. 26A and B the gaming device 2000 hardware 501 for their controller(s) is shown in accordance with one or more embodiments. The hardware 501 includes base game integrated circuit board 503 (EGM Processor Board) connected through serial bus line 505 to game monitoring unit (GMU) 507 (such as a Bally MC300 or ACSC NT), and player interface integrated circuit board (PIB) 509 connected to player system interface devices 511 over bus lines 513, 517, 519, 521, 523. Gaming voucher ticket printer 525 (for printing player cashout tickets) is connected to PIB 509 and GMU 507 over bus lines 527, 529. EGM Processor Board 503, PIB 509, and GMU 507 connect to Ethernet switch 531 over bus lines 533, 535, 537. Ethernet switch 531 connects to a slot management system (SMS) and a casino management system (CMS) network over bus line 539. Ethernet switch 531 may also connect to a server based gaming server or a downloadable gaming server. GMU 507 also may connect to the SMS and CMS network over bus line 541. Speakers 543 to produce sounds related to the game or according to the present invention connect through audio mixer 545 and bus lines 547, 549 to EGM Processor Board 503 and PIB 509.

Peripherals 551 connect through bus 553 to EGM Processor Board 503. The peripherals 551 include, but are not limited to the following and may include individual processing capability: bill/ticket acceptor to validate and accept currency and ticket vouchers, player loyalty card reader, the player interfaces 208, 308A, 408A including features to support the touch screen/gesture functionality, display 204, 304, 404 with touch screen/gesture recognition functionality, monitors and lights. For example, a bill/ticket acceptor is typically connected to the game input-output board of the EGM processing board 503 (which is, in turn, connected to a conventional central processing unit (“CPU”) board), such as an Intel Pentium microprocessor mounted on a gaming motherboard. The I/O board may be connected to CPU processor board by a serial connection such as RS-232 or USB or may be attached to the processor by a bus such as, but not limited to, an ISA bus. The gaming motherboard may be mounted with other conventional components, such as are found on conventional personal computer motherboards, and loaded with a game program which may include a gaming machine operating system (OS), such as a Bally Alpha OS. EGM processor board 503 executes a game program that causes the gaming device 2200 to display and play a game. The various components and included devices may be installed with conventionally and/or commercially available components, devices, and circuitry into a conventional and/or commercially available gaming device cabinet 2202, examples of which are described above.

When a player has inserted a form of currency such as, for example and without limitation, paper currency, coins or tokens, cashless tickets or vouchers, electronic funds transfers or the like into the currency acceptor, a signal is sent by way of bus 553 to the I/O board and to EGM processor board 503 which, in turn, assigns an appropriate number of credits for play in accordance with the game program. The player may further control the operation of the gaming device 2200 by way of other peripherals 551, for example, to select the amount to wager via the player interface 208, 308A, 408A. The game starts in response to the player operating a start mechanism such as a handle, button such as a SPIN/RESET button touch screen icon or depressing button 2218. The game program includes a random number generator to provide a display of randomly selected indicia on one or more of the main and/or secondary displays 2208, 2210. In some embodiments, the random generator may be physically separate from gaming device 2000; for example, it may be part of a central determination host system which provides random game outcomes to the game program. Finally, processor board 503 under control of the game program and OS compares the final display of indicia to a pay table. The set of possible game outcomes may include a subset of outcomes related to the triggering of a feature or bonus game. In the event the displayed outcome is a member of this subset, processor board 503, under control of the game program and by way of I/O Board 553, may cause feature game play to be presented on the display(s) 2208,2210.

Predetermined payout amounts for certain outcomes, including feature game outcomes, are stored as part of the game program. Such payout amounts are, in response to instructions from processor board 503, provided to the player in the form of coins, credits or currency via I/O board and a pay mechanism, which may be one or more of a credit meter, a coin hopper, a voucher printer, an electronic funds transfer protocol or any other payout means known or developed in the art.

In various embodiments, the game program is stored in a memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In one embodiment, the remote storage device is housed in a remote server such as a downloadable gaming server. The gaming machine may access the remote storage device via a network connection, including but not limited to, a local area network connection, a TCP/IP connection, a wireless connection, or any other means for operatively networking components together. Optionally, other data including graphics, sound files and other media data for use with the EGM are stored in the same or a separate memory device (not shown). Some or all of the game program and its associated data may be loaded from one memory device into another, for example, from flash memory to random access memory (RAM).

In one or more embodiments, peripherals may be connected to the system over Ethernet connections directly to the appropriate server or tied to the system controller inside the EGM using USB, serial or Ethernet connections. Each of the respective devices may have upgrades to their firmware utilizing these connections.

GMU 507 includes an integrated circuit board and GMU processor and memory including coding for network communications, such as the G2S (game-to-system) protocol from the Gaming Standards Association, Las Vegas, Nev., used for system communications over the network. As shown, GMU 507 may connect to a player card reader 555 through bus 557 and may thereby obtain player card information and transmit the information over the network through bus 541. Gaming activity information may be transferred by the EGM Processor Board 503 to GMU 507 where the information may be translated into a network protocol, such as S2S, for transmission to a server, such as a player tracking server, where information about a player's playing activity may be stored in a designated server database.

PID 509 includes an integrated circuit board, PID processor, and memory which includes an operating system, such as Windows CE, a player interface program which may be executable by the PID processor together with various input/output (I/O) drivers for respective devices which connect to PID 509, such as player interface devices 511, and which may further include various games or game components playable on PID 509 or playable on a connected network server and PID 509 is operable as the player interface. PID 509 connects to card reader 555 through bus 523, player tracking display 559 through video decoder 561 and bus 521, such as an LVDS or VGA bus.

As part of its programming, the PID processor executes coding to drive player tracking display 559 and provide messages and information to a player. Touch screen circuitry 563 interactively connects display 559 and video decoder 561 to PID 509, such that a player may input information and cause the information to be transmitted to PID 509 either on the player's initiative or responsive to a query by PID 509. Additionally soft keys 565 connect through bus 517 to PID 509 and operate together with the player tracking display 559 to provide information or queries to a player and receive responses or queries from the player. PID 509, in turn, communicates over the CMS/SMS network through Ethernet switch 531 and busses 535, 539 and with respective servers, such as a player tracking server described above.

Player interface devices 511 are linked into the virtual private network of the system components in gaming machine 501. The system components include the iVIEW® device (‘iView” is a registered trademark of Bally Gaming, Inc.) processing board and game monitoring unit (GMU) processing board. These system components may connect over a network to the slot management system (such as a commercially available Bally SDS/SMS) and/or casino management system (such as a commercially available Bally CMP/CMS).

The GMU system component has a connection to the base game through a serial SAS connection and is connected to various servers using, for example, HTTPs over Ethernet. Through this connection, firmware, media, operating system software, gaming machine configurations can be downloaded to the system components from the servers. This data is authenticated prior to install on the system components.

Turning to FIG. 27 is a functional block diagram of a gaming kernel 600 of a game program under control of processor board 503, uses gaming kernel 600 by calling into application programming interface (API) 602, which is part of game manager 603. The components of game kernel 600 as shown in FIG. 27 are only illustrative, and should not be considered limiting. For example, the number of managers may be changed, additional managers may be added or some managers may be removed without deviating from the scope and spirit of the invention.

As shown in the example, there are three layers: a hardware layer 605; an operating system layer 610, such as, but not limited to, Linux; and a game kernel layer 600 having game manager 603 therein. In one or more embodiments, the use of a standard operating system 610, such a UNIX-based or Windows-based operating system, allows game developers interfacing to the gaming kernel to use any of a number of standard development tools and environments available for the operating systems. This is in contrast to the use of proprietary, low level interfaces which may require significant time and engineering investments for each game upgrade, hardware upgrade, or feature upgrade. The game kernel layer 600 executes at the user level of the operating system 610, and itself contains a major component called the I/O Board Server 615. To properly set the bounds of game application software (making integrity checking easier), all game applications interact with gaming kernel 600 using a single API 602 in game manager 603. This enables game applications to make use of a well-defined, consistent interface, as well as making access points to gaming kernel 600 controlled, where overall access is controlled using separate processes.

For example, game manager 603 parses an incoming command stream and, when a command dealing with I/O comes in (arrow 604), the command is sent to an applicable library routine 612. Library routine 612 decides what it needs from a device, and sends commands to I/O Board Server 615 (see arrow 608). A few specific drivers remain in operating system 610's kernel, shown as those below line 606. These are built-in, primitive, or privileged drivers that are (i) general (ii) kept to a minimum and (iii) are easier to leave than extract. In such cases, the low-level communications is handled within operating system 610 and the contents passed to library routines 612.

Thus, in a few cases library routines may interact with drivers inside operating system 610, which is why arrow 608 is shown as having three directions (between library utilities 612 and I/O Board Server 615, or between library utilities 612 and certain drivers in operating system 610). No matter which path is taken, the logic needed to work with each device is coded into modules in the user layer of the diagram. Operating system 610 is kept as simple, stripped down, and common across as many hardware platforms as possible. The library utilities and user-level drivers change as dictated by the game cabinet or game machine in which it will run. Thus, each game cabinet or game machine may have an industry standard processor board 505 connected to a unique, relatively dumb, and as inexpensive as possible I/O adapter board 540, plus a gaming kernel 600 which will have the game-machine-unique library routines and I/O Board Server 615 components needed to enable game applications to interact with the gaming machine cabinet. Note that these differences are invisible to the game application software with the exception of certain functional differences (i.e., if a gaming cabinet has stereo sound, the game application will be able make use of API 602 to use the capability over that of a cabinet having traditional monaural sound).

Game manager 603 provides an interface into game kernel 600, providing consistent, predictable, and backwards compatible calling methods, syntax, and capabilities by way of game application API 602. This enables the game developer to be free of dealing directly with the hardware, including the freedom to not have to deal with low-level drivers as well as the freedom to not have to program lower level managers 630, although lower level managers 630 may be accessible through game manager 603's interface 602 if a programmer has the need. In addition to the freedom derived from not having to deal with the hardware level drivers and the freedom of having consistent, callable, object-oriented interfaces to software managers of those components (drivers), game manager 603 provides access to a set of upper level managers 620 also having the advantages of consistent callable, object-oriented interfaces, and further providing the types and kinds of base functionality required in casino-type games. Game manager 603, providing all the advantages of its consistent and richly functional interface 602 as supported by the rest of game kernel 600, thus provides a game developer with a multitude of advantages.

Game manager 603 may have several objects within itself, including an initialization object (not shown). The initialization object performs the initialization of the entire game machine, including other objects, after game manager 603 has started its internal objects and servers in appropriate order. In order to carry out this function, the kernel's configuration manager 621 is among the first objects to be started; configuration manager 621 has data needed to initialize and correctly configure other objects or servers.

The upper level managers 620 of game kernel 600 may include game event log manager 622 which provides, at the least, a logging or logger base class, enabling other logging objects to be derived from this base object. The logger object is a generic logger; that is, it is not aware of the contents of logged messages and events. The log manager's (622) job is to log events in non-volatile event log space. The size of the space may be fixed, although the size of the logged event is typically not. When the event space or log space fills up, one embodiment will delete the oldest logged event (each logged event will have a time/date stamp, as well as other needed information such as length), providing space to record the new event. In this embodiment, the most recent events will thus be found in the log space, regardless of their relative importance. Further provided is the capability to read the stored logs for event review.

In accordance with one embodiment, meter manager 623 manages the various meters embodied in the game kernel 600. This includes the accounting information for the game machine and game play. There are hard meters (counters) and soft meters; the soft meters may be stored in non-volatile storage such as non-volatile battery-backed RAM to prevent loss. Further, a backup copy of the soft meters may be stored in a separate non-volatile storage such as EEPROM. In one embodiment, meter manager 623 receives its initialization data for the meters, during startup, from configuration manager 621. While running, the cash in (624) and cash out (625) managers call the meter manager's (623) update functions to update the meters. Meter manager 623 will, on occasion, create backup copies of the soft meters by storing the soft meters' readings in EEPROM. This is accomplished by calling and using EEPROM manager 631.

In accordance with still other embodiments, progressive manager 626 manages progressive games playable from the game machine. Event manager 627 is generic, like log manager 622, and is used to manage various gaming device events. Focus manager 628 correlates which process has control of various focus items. Tilt manager 632 is an object that receives a list of errors (if any) from configuration manager 621 at initialization, and during game play from processes, managers, drivers, etc. that may generate errors. Random number generator manager 629 is provided to allow easy programming access to a random number generator (RNG), as a RNG is required in virtually all casino-style (gambling) games. RNG manager 629 includes the capability of using multiple seeds.

In accordance with one or more embodiments, a credit manager object (not shown) manages the current state of credits (cash value or cash equivalent) in the game machine, including any available winnings, and further provides denomination conversion services. Cash out manager 625 has the responsibility of configuring and managing monetary output devices. During initialization, cash out manager 625, using data from configuration manager 621, sets the cash out devices correctly and selects any selectable cash out denominations. During play, a game application may post a cash out event through the event manager 627 (the same way all events are handled), and using a call back posted by cash out manager 625, cash out manager 625 is informed of the event. Cash out manager 625 updates the credit object, updates its state in non-volatile memory, and sends an appropriate control message to the device manager that corresponds to the dispensing device. As the device dispenses dispensable media, there will typically be event messages being sent back and forth between the device and cash out manager 625 until the dispensing finishes, after which cash out manager 625, having updated the credit manager and any other game state (such as some associated with meter manager 623) that needs to be updated for this set of actions, sends a cash out completion event to event manager 627 and to the game application thereby. Cash in manager 624 functions similarly to cash out manager 625, only controlling, interfacing with, and taking care of actions associated with cashing in events, cash in devices, and associated meters and crediting.

In a further example, in accordance with one or more embodiments, I/O server 615 may write data to the gaming machine EEPROM memory, which is located in the gaming machine cabinet and holds meter storage that must be kept even in the event of power failure. Game manager 603 calls the I/O library functions to write data to the EEPROM. The I/O server 615 receives the request and starts a low priority EEPROM thread 616 within I/O server 615 to write the data. This thread uses a sequence of 8 bit command and data writes to the EEPROM device to write the appropriate data in the proper location within the device. Any errors detected will be sent as IPC messages to game manager 603. All of this processing is asynchronous.

In accordance with one embodiment, button module 617 within I/O server 615, polls (or is sent) the state of buttons every two milliseconds. These inputs are debounced by keeping a history of input samples. Certain sequences of samples are required to detect a button was pressed, in which case the I/O server 615 sends an inter-process communication event to game manager 603 that a button was pressed or released. In some embodiments, the gaming machine may have intelligent distributed I/O which debounces the buttons, in which case button module 617 may be able to communicate with the remote intelligent button processor to get the button events and simply relay them to game manager 603 via IPC messages. In still another embodiment, the I/O library may be used for pay out requests from the game application. For example, hopper module 618 must start the hopper motor, constantly monitor the coin sensing lines of the hopper, debounce them, and send an IPC message to the game manager 603 when each coin is paid.

Further details, including disclosure of lower level fault handling and/or processing, are included in U.S. Pat. No. 7,351,151 entitled “Gaming Board Set and Gaming Kernal for Game Cabinets” and provisional U.S. patent application No. 60/313,743, entitled “Form Fitting Upgrade Board Set For Existing Game Cabinets,” filed Aug. 20, 2001; said patent and provisional are both fully incorporated herein by explicit reference.

Referring to FIGS. 8A and B, an enterprise gaming system 801 is shown in accordance with one or more embodiments. Enterprise gaming system 801 may include one casino or multiple locations and generally includes a network of gaming devices 803, floor management system (SMS) 805, and casino management system (CMS) 807. SMS 805 may include load balancer 811, network services servers 813, player interface (iVIEW®) content servers 815, certificate services server 817, floor radio dispatch receiver/transmitters (RDC) 819, floor transaction servers 821 and game engines 823, each of which may connect over network bus 825 to gaming machines 803. CMS 807 may include location tracking server 831, WRG RTCEM server 833, data warehouse server 835, player tracking server 837, biometric server 839, analysis services server 841, third party interface server 843, slot accounting server 845, floor accounting server 847, progressives server 849, promo control server 851, bonus game (such as Bally Live Rewards) server 853, download control server 855, player history database 857, configuration management server 859, browser manager 861, tournament engine server 863 connecting through bus 865 to server host 867 and gaming machines 803. The various servers and gaming machines 803 may connect to the network with various conventional network connections (such as, for example, USB, serial, parallel, RS485, Ethernet). Additional servers which may be incorporated with CMS 807 include a responsible gaming limit server (not shown), advertisement server (not shown), and a control station server (not shown) where an operator or authorized personnel may select options and input new programming to adjust each of the respective servers and gaming machines 803. SMS 805 may also have additional servers including a control station (not shown) through which authorized personnel may select options, modify programming, and obtain reports of the connected servers and devices, and obtain reports. The various CMS and SMS servers are descriptively entitled to reflect the functional executable programming stored thereon and the nature of databases maintained and utilized in performing their respective functions.

Gaming devices 803 include various peripheral components that may be connected with USB, serial, parallel, RS-485 or Ethernet devices/architectures to the system components within the respective gaming machine. The GMU has a connection to the base game through a serial SAS connection. The system components in the gaming cabinet may be connected to the servers using HTTPs or G2S over Ethernet. Using CMS 807 and/or SMS 305 servers and devices, firmware, media, operating systems, and configurations may be downloaded to the system components of respective gaming devices for upgrading or managing floor content and offerings in accordance with operator selections or automatically depending upon CMS 807 and SMS 805 master programming. The data and programming updates to gaming devices 803 are authenticated using conventional techniques prior to install on the system components.

In various embodiments, any of the gaming devices 803 may be a mechanical reel spinning slot machine, video slot machine, video poker machine, video bingo machine, keno machine, or a gaming device offering one or more of the above described games including an interactive wheel feature. Alternately, gaming devices 803 may provide a game with an accumulation-style feature game as one of a set of multiple primary games selected for play by a random number generator, as described above. A gaming system of the type described above also allows a plurality of games in accordance with the various embodiments of the invention to be linked under the control of a group game server (not shown) for cooperative or competitive play in a particular area, carousel, casino or between casinos located in geographically separate areas. For example, one or more examples of group games under control of a group game server are disclosed in U.S. application Ser. No. 11/938,079, entitled “Networked System and Method for Group Gaming,” filed on Nov. 9, 2007, which is hereby incorporated by reference in its entirety for all purposes.

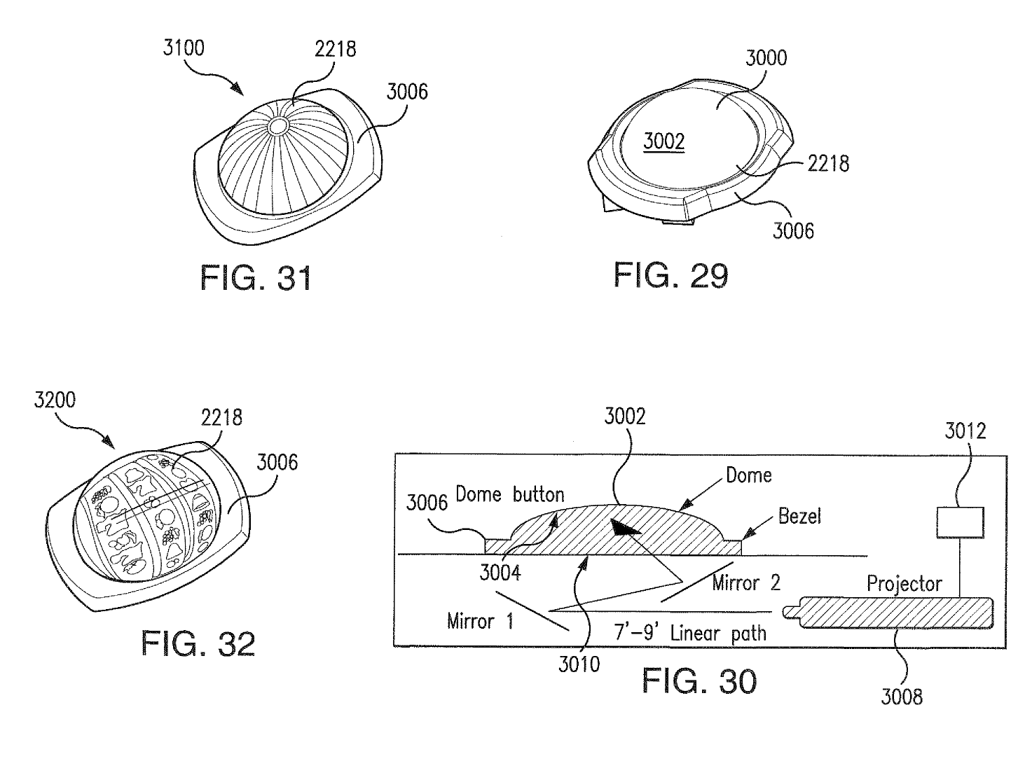

Turning now to FIGS. 29 and 30 the button 2218 for the player interface 2216 will be described in detail. The button 2218 is spherical including a three-dimensional screen 3000 of a type designed to be backlit such as that described with reference to the gaming device embodiment of FIGS. 1-5. For example the button 2218 may be fashioned from a rugged transparent plastic including a smooth, polished spherical exterior surface 3002 and interior surface 3004 configured to define the screen. To define the screen the interior surface 3004 may be coated with an optical coating such as Polacoat® wide angle optical coating (Polacoat® is a registered trademark of DA-LITE SCREEN COMPANY, INC. of Warsaw, Ind.). Any other coating or treatment may be used to define the backlit screen for the button 2218. Further while the interior surface 3304 of the button 2218 may define the screen, the screen may be a separate component of the button 2218 such as a membrane or the like spaced from or partially spaced from the interior surface 3004. Preferably the screen is three dimensional. Where the button 2218 is fashioned for example from moulded plastic into the spherical shape having the spherical exterior and interior surfaces and where the screen is defined by the interior surface, the screen is thusly shaped as a three dimensional spherical screen. It has a height and width defined by the diameter of the button 2218 with a depth defined by the radial depth of the button. The screen may have, when not displaying images, a grey, white or mirrored appearance. Further the screen, and where the screen is defined by the exterior and interior surfaces 3002, 3004 may have other three dimensional shapes such as a face, animal, letter, number or other object or shape.

The three dimensional shape of the button 2218 and screen may also be cubical, pyramidal, conical, domed-shaped or any other shape which can result in a three dimensional screen.

To retain the button 2218 on the interface substrate 2214 a bezel 3006 is provided.

To provide images to the button 2218, a digital light projector (DLP) 3008 is provided in the interface 2216 or separately. Other projectors may be used in lieu of a DLP such as a light emitting diode projector or the like. DLP 3008 may be of the type described above and is disposed to direct images onto the screen. As shown in FIG. 30 the DLP 3008 is included in the cabinet 2202 or interface 2216 to project images to the interior surface 3004 at the underside of the button 2218. Accordingly the button 2218 by its three dimensional shape creates an open path 3010 to its interior surface 3004 and screen defined thereat. The DLP 3008 may be positioned to render images directly on the screen or, as shown in FIG. 30, may use one or more reflecting surfaces 3010 which can be defined as mirrors, prisms or the like. Where the DLP 3008 has a throw ratio R and the screen has a width (e.g. diameter) W the reflecting surfaces 3010 are positioned such the optical path distance D from the DLP 3008 to the screen (in this embodiment the interior surface 3004 which defines the screen) satisfies the equation: R=D/W (the equation for the throw ratio). Thus the reflecting surfaces 3010 fix the distance to the throw ratio of the DLP 3008 so that the images fill the screen. Of course the distance D could be altered to over fill or under fill the screen as desired.

To control the DLP 3008 a processor 3012 is provided. The processor 3012 may be a video processor and may also include a memory device such as a flash card or the like to include images/video to display at the screen. The processor 3012 may also be included on the EGM processor board 503 (FIG. 26B) or in the player interface device 511. Where the interface 2216 is fashioned as a retrofit unit the processor 3012 would be included in the unit or module.

The processor 3012 preferably interfaces with one or both of the EGM processor board 503 and player interface device 511 so that the images/video produced at the button 2218 can be integrated into the play of the game, bonuses or other features as well as display system related images. For example the button 2218 may act as a self-contained bonus wheel or replication of a bonus wheel peripheral for the game. Turning to FIG. 31, there is shown an example where the DLP 3008 is controlled to render images of a bonus wheel 3100 at the button 2218 screen. The player would be invited to depress the button 2218 whereupon a random number generator (at the processor 3012 or EGM processor board 503) randomly selects a bonus outcome and controls the DLP 3012 to display the wheel rotating and stopping at the selected bonus award. In this fashion the interface 2216 can provide a separate bonus perhaps as a retrofit unit to an existing gaming device. Alternatively the gaming device 2200 may have a separate display of the bonus wheel for example in the secondary display 2210 and the images rendered at the screen for the button 2218 replicate the wheel shown in the secondary display 2210 to invite the player to depress the button 2218 to prompt the depressing of the button 2218 to spin of the wheel and increase the aesthetic appearance of the gaming device 2210 through the coordination of the images between the button 2218 and the images displayed at other displays of the gaming device 2200. FIG. 32 illustrates the images from the DLP 3008 displaying reels 3200 for a slot machine game. These reels may be used to issue a separate bonus to the player or replicate the display of reels at the main game display 2208 or for other purposes.

The three dimensional screen and images rendered by the DLP 3008 are configured to produce images that have a three dimensional appearance. For example, the button 2218 may take on the appearance of a three dimensional ball, wheel 3100 or reels 3200, rolling die, a coconut shell, baseball, globe or the like.

The images at the button 2218 may relate to and be coordinated with the game or a feature of the game. Additionally the images at the button may relate to the function of the button 2218 such as by showing “BONUS” or “SPIN”, may display information, advertising or instructional material. The images may be stored locally at the processor 3012, EGM processor board 503 or may be downloaded from the network. The images also may change depending upon the game being played to conform therewith.

As stated above the interface 2216 may be fashioned as a module to be integrated into a newly manufactured gaming device 2000 or an existing gaming device 2000. The processor 3012 and/or DLP 3008 may be connected to either or both of the EGM processor board 503 or player interface device 511 with a USB or other standard power/data connector. A separate power connector may also be provided for the DLP 3008.

As stated above the features of the present invention are well adapted for a display terminal such as an airline ticketing or check in kiosk, automatic teller machine or vending kiosk. The images provided at the button may be icons to assist the user. For example, where the device is an airline check-in kiosk and the player is asked if they have bags to check, the button 2218 would display images of baggage. Where the kiosk is idle advertising operated by the airport terminal could be displayed at the buttons.

In another embodiment, the gaming device 10, 2000 includes an internet connection or other known network connections to link one or more gaming devices together. According to one embodiment, the internet connection is used for web browsing, prize redemption, or access to other gaming or non-gaming information. Additionally, with the various gaming machines in communication with one another (or a system host), the gaming devices 10, 2000 may participate in a gaming tournament. In one embodiment, the gaming tournament is a competitive gaming tournament having one or more winners. Alternatively, the gaming tournament is a cooperative gaming tournament where all eligible gaming machines win a particular award.

One of ordinary skill in the art will appreciate that not all gaming devices have all these components and may have other components in addition to, or in lieu of, those components mentioned here. Furthermore, while these components are viewed and described separately, various components may be integrated into a single unit in some embodiments.

The various embodiments and methods described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. An improved display terminal device of the type including a display and a controller to control the display to display content, said improvement comprising:
a button which can be manipulated by a user to provide an input signal to the controller, said button having a three dimensional screen viewable by the user;
a digital projector to backlight images onto said screen, said images adapted to render at said screen images which appear to the user to be three dimensional; and
a processor to control said projector to project said images.

2. The device of claim 1 comprising said button is a push button.

3. The device of claim 1 comprising said screen is spherical, pyramidal, cubical or parallelopipedal.

4. The device of claim 1 comprising said button is three-dimensional including and outer and an inner surface and said inner surface defines said screen.

5. The device of claim 4 comprising said button is transparent including at said interior surface a coating to define said screen for backlighting.

6. The device of claim 5 comprising said button is spherical, pyramidal, cubical or parallelopipedal.

7. The device of claim 1 comprising said digital projector has a throw ratio and apparatus to fix the optical path distance between said projector and said screen to fit said images to said screen.

8. The device of claim 7 comprising said apparatus are at least one reflector.

9. The device of claim 8 comprising said reflector is a mirror.

10. The device of claim 1 comprising at least one of said controller and processor is configured to render said images in coordination with said content.

11. A method for a user to provide input to a display terminal of the type having a display and a controller controlling the display to display content, said method comprising:
providing an input button which can be displaced by a user to provide input to the controller, said button including a three dimensional screen viewable by the user;
positioning a digital projector to backlight said screen with images rendered to provide, in cooperation with said screen, a three dimensional affect to said button; and
configuring a processor to control said images.

12. The method of claim 11 comprising providing a button having a three dimensional shape having an outer surface and an inner surface defining said screen.

13. The method of claim 12 comprising providing a button that is transparent including at said interior surface a coating to define said screen for backlighting.

14. The method of claim 13 comprising providing a button defining a screen that is spherical, pyramidal, cubical or parallelopipedal.

15. The method of claim 11 comprising said projector has a throw ratio, said method comprising setting the optical path distance between said projector and said screen to fit said images to said screen.

16. The method of claim 15 comprising reflecting the optical path at least once to set said optical path distance.

17. The method of claim 11 comprising processing said images in coordination with said content.

18. An improved gaming device of the type including a display and a controller to control the display to display content, said device comprising:
a button which can be manipulated by a user to provide an input signal to the controller, said button having a three dimensional screen viewable by the user;
a digital projector to backlight images onto said screen, said images adapted to render at said screen images which appear to the user to be three dimensional; and
a processor to control said projector to project said images.

19. The device of claim 18 comprising said button is a push button.

20. The device of claim 18 comprising said screen is spherical, pyramidal, cubical or parallelopipedal.

21. The device of claim 18 comprising said button is three-dimensional including and outer and an inner surface and said inner surface defines said screen.

22. The device of claim 21 comprising said button is transparent including at said interior surface a coating to define said screen for backlighting.

23. The device of claim 22 comprising said button is spherical, pyramidal, cubical or parallelopipedal.

24. The device of claim 18 comprising said digital projector has a throw ratio and apparatus to fix the optical path distance between said projector and said screen to fit said images to said screen.

25. The device of claim 24 comprising said apparatus are at least one reflector.

26. The device of claim 25 comprising said reflector is a mirror.

27. The device of claim 18 comprising at least one of said controller and processor is configured to render said images in coordination with said content.

28. A method for configuring a gaming device of the type including a display and a controller which controls the display to display game content, said method comprising;
providing a transparent input button which can be displaced by a player to provide, said button having a three dimensional shape with an exterior and interior surface, one of said surfaces arranged as a three dimensional backlit screen;
locating a digital projector for projecting images to backlight said screen to render images having a three dimensional appearance to the player;
including a processor to control said digital processor to render said images.

29. The method of claim 28 comprising operating at least one of the controller and processor to control the images in coordination with said content.

30. The method of claim 28 comprising providing said button including a three dimensional shape of spherical, pyramidal, cubical or parallelopipedal.

31. The method of claim 28 comprising providing said button interior surface to include said backlit screen.

32. The method of claim 28 comprising said projector having a throw ratio, the method comprising setting the optical path distance between said projector and said screen to fit said images to said screen.

33. The method of claim 32 comprising reflecting the images to set said optical path distance.

34. A gaming device having comprising:
a display;
a controller configured to control the display to display game content defining an outcome for a play;
a button displaceable to render an input to the controller, said button having a three dimensional body defining an exterior surface and an interior surface, at least one of said surfaces defining a screen to present backlit images to the player;
a digital projector to direct images onto said screen;
a processor to control said projector images; and
said controller configured to, in response to said displayed content, cooperate with said processor to render images at said screen in cooperation with at least said content.

35. A button module for a device of the type having a controller controlling a display to display content to a user, said button module comprising:
a substrate;
a button moveably disposed on the substrate, said button having a three dimensional shape with an exterior surface and an interior surface at least a portion of which defines a screen;
a digital projector to project images to backlight said screen to render images viewable by the user;
a processor to control the images, said images configured to cooperate with the said screen to render three dimensional images at said button.

36. The module of claim 35 comprising said button is a push button.

37. The module of claim 35 comprising said screen is spherical, pyramidal, cubical or parallelopipedal.

38. The module of claim 35 comprising said button is transparent including at said interior surface a finish to define said screen for backlighting.

39. The module of claim 35 comprising said button is spherical, pyramidal, cubical or parallelopipedal.

40. The module of claim 35 comprising said digital projector has a throw ratio and apparatus to fix the optical path distance between said projector and said screen to fit said images to said screen.

41. The module of claim 40 comprising said apparatus are at least one reflector.

42. The module of claim 41 comprising said reflector is a mirror.

43. The module of claim 35 comprising a coupling for communication between said processor and said controller.

44. The module of claim 43 comprising said coupling is a USB coupling.

45. An improved display terminal of the type including at least one display and a controller to control the content displayed at the display and adapted to be connected to a host through a communication network, the improvement comprising:
a communication device to enable communication between the gaming device and the host over said network;
a button displaceable by a user to render an input to the one of the controller or host, said button having a three dimensional body defining an exterior surface and an interior surface, at least one of said surfaces defining a screen to present backlit images to the user;
a digital projector to direct images onto said screen;
a processor to control said projector images; and
at least one of said communication device and processor receiving data from said host to control the images displayed at said button.
